(19) United States
(12) Patent Application Publication
(10) Pub. No.: US 2019/0226985 A1
(43) Pub. Date: Jul. 25, 2019

(54) ANALYTICAL TEST DEVICE

(71) Applicant: Sumitomo Chemical Company Limited, Tokyo (JP)

(72) Inventors: Matthew Roberts, Godmanchester (GB); Andrey Nikolaenko, Godmanchester (GB); May Wheeler, Godmanchester (GB)

(73) Assignee: Sumitomo Chemical Company Limited, Tokyo (JP)

(21) Appl. No.: 16/336,822

(22) PCT Filed: Sep. 25, 2017
(86) PCT No.: PCT/GB2017/052859

§ 371 Date: Mar. 26, 2019

(30) Foreign Application Priority Data
Sep. 26, 2016 (GB) 1616301.6
Mar. 30, 2017 (GB) 1705161.6

(51) Int. Cl. G01N 21/25; G01N 21/31; G01N 21/27; B01L 3/00

(52) U.S. Cl. CPC G01N 21/256; G01N 21/3151; G01N 21/6428; B01L 3/502; G01N 21/274

(57) ABSTRACT

An analytical test device (i) includes two or more sets of emitters (2, 3, 98, 101), each set of emitters (2, 3, 98, 101) comprising one or more light emitters (2, 3, 98, 101) configured to emit light within a range around a corresponding wavelength. Each set of light emitters (2, 3, 98, 101) is configured to be independently illuminable. The test device (1) also includes one or more photodetectors (4) arranged such that light from each set of emitters (2, 3, 98, 101) reaches the photodetectors (4) via an optical path (7) comprising a sample receiving portion (8). The emitters (2, 3, 98, 101) and photodetectors (4) are configured such that, at the sample receiving portion (8) of the optical path (7), a normalised spatial intensity profile generated by each set of emitters (2, 3, 98, 101) is substantially equal to a normalised spatial intensity profile generated by each other set of emitters (2, 3, 98, 101). The test device (1) also includes a liquid transport path (41) comprising a first end (43), a second end (4$) and a liquid sample receiving region (42). The liquid transport path (41) is configured to transport a liquid sample received in the liquid sample receiving region (42) towards the second end (44) and through the sample receiving portion (8) of the optical path (7).

### FIELD OF THE INVENTION

The present invention relates to an analytical test device.

### BACKGROUND

Biological testing for the presence and/or concentration of an analyte may be conducted for a variety of reasons including, amongst other applications, preliminary diagnosis, screening samples for presence of controlled substances and management of long term health conditions.

Lateral flow devices (also known as “lateral flow immunoassays”) are one variety of biological testing. Lateral flow devices may be used to test a liquid sample, such as saliva, blood or urine, for the presence of an analyte. Examples of lateral flow devices include home pregnancy tests, home ovulation tests, tests for other hormones, tests for specific pathogens and tests for specific drugs. For example, EP 0 291194 A1 describes a lateral flow device for performing a pregnancy test.

In a typical lateral flow testing strip, a liquid sample is introduced at one end of a porous strip which is then drawn along the strip by capillary action (or “wicking”). A portion of the lateral flow strip is pre-treated with labelling particles which are activated with a reagent which binds to the analyte to form a complex, if the analyte is present in the sample. The bound complexes and also unreacted labelling particles continue to propagate along the strip before reaching a testing region which is pre-treated with an immobilised binding reagent which binds bound complexes of analyte and labelling particles and does not bind unreacted labelling particles. The labelling particles have a distinctive colour, or other detectable optical or non-optical property, and the development of a concentration of labelling particles in the test regions provides an observable indication that the analyte has been detected. Lateral flow test strips may be based on, for example, colorimetric labelling using gold or latex nanoparticles, fluorescent marker molecules or magnetic labelling particles.

Another variety of biological testing involves assays conducted in liquids held in a container such as a vial, a PCR well/plate, a cuvette or a microfluidic cell. Liquid assays may be measured based on colorimetry or fluorescence. An advantage of some liquid based assays is that they may allow tests to be conducted using very small (e.g. picolitre) volumes.

Sometimes, merely determining the presence or absence of an analyte is desired, i.e. a qualitative test. In other applications, an accurate concentration of the analyte may be desired, i.e. a quantitative test. For example, WO 2008/101732 A1 describes an optical measuring instrument and measuring device. The optical measuring instrument includes at least one source for providing at least one electromagnetic beam to irradiate a sample and to interact with the specimen within the sample, at least one sensor for detecting an output of the interaction between the specimen and the electromagnetic beam, an integrally formed mechanical bench for the optical and electronic components and a sample holder for holding the sample. The at least one source, the at least one sensor, and the mechanical bench are integrated in one monolithic optoelectronic module and the sample holder can be connected to this module.

Quantitative detectors for biological testing methods may require optical components such as beamsplitters, lenses, monochromators, filters and so forth. Such components may be complex, expensive and/or bulky, and may have properties which vary considerably with the wavelength of light. Optical components such as beamsplitters, lenses, monochromators, filters and so forth are typically too bulky for integration into a single use, self-contained lateral flow immunoassay test or a self-contained microfluidic assay test.

Biological samples which may contain an analyte of interest may be coloured, for example blood or urine. Conventionally, coloured samples have been treated by filtering out the coloured dye (eg filtering full red blood to obtain clear serum) or by introducing a washing/flushing step.

### SUMMARY

According to a first aspect of the invention there is provided an analytical test device including two or more sets of emitters, each set of emitters comprising one or more light emitters configured to emit light within a range around a corresponding wavelength. Each set of light emitters is configured to be independently illuminable. The test device also includes one or more photodetectors arranged such that light from each set of emitters reaches the photodetectors via an optical path comprising a sample receiving portion. The emitters and photodetectors are configured such that, at the sample receiving portion of the optical path, a normalised spatial intensity profile generated by each set of emitters is substantially equal to a normalised spatial intensity profile generated by each other set of emitters. The test device also includes a liquid transport path comprising a first end, a second end and a liquid sample receiving region. The liquid transport path is configured to transport a liquid sample received in the liquid sample receiving region towards the second end and through the sample receiving portion of the optical path.

Absorbance measurements obtained using the two or more sets of emitters may be de-convoluted (de-mixed) to quantify the concentration of one or more analytes whilst also compensating for optical scattering due to defects or other inhomogeneities of a sample.

Thus, the analytical test device can provide improved signal to noise ratio for simultaneous measurements of one or more analytes.

Thus, the analytical test device may include a simplified optical path which does not require optical components such as filters or monochromators to perform dual-wavelength measurements. Thus, the analytical test device may be less bulky and simpler to manufacture.

The test device may also include a controller configured to sequentially illuminate each set of emitters and to obtain a corresponding measured absorbance value using the photodetectors, such that only one set of emitters is illuminated at any time. The controller may also be configured to generate an absorbance vector using the measured absorbance values. The controller may also be configured to determine a concentration vector by multiplying the absorbance vector with a de-convolution matrix (also referred to as a de-mixing matrix).

Each set of emitters emits light within a range around a wavelength which is different to each of the other sets of emitters.

The two or more sets of emitters may include a set of first light emitters configured to emit within a range around a first wavelength, and a set of second light emitters configured to emit within a range around a second wavelength. The two or more sets of emitters may also include a set of third light emitters configured to emit within a range around a third wavelength. The two or more sets of emitters may include a set of fourth light emitters configured to emit within a range around a fourth wavelength.

The controller may be configured to subtract a signal obtained at a reference wavelength, for example the second wavelength, from a signal obtained at a measurement wavelength, for example the first wavelength, in order to compensate for optical scattering due to defects or other inhomogeneities in a medium or on a substrate holding a sample.

Thus, using first and second separate, alternately illuminable emitters which provide substantially equal normalised spatial intensity profiles, absorbance measurements may be corrected using measurements at a reference wavelength. In this way, the analytical test device can provide improved signal to noise ratio.

The wavelength corresponding to each set of emitters may correspond to a peak emission wavelength of the emitters. Each set of emitters may emit light within a range having a full-width at half maximum of no more than 10 nm, no more than 25 nm, no more than 50 nm, no more than 100 nm or no more than 200 nm.

The optical path may include no monochromators. The optical path may include no beamsplitters between the sample receiving portion and the photodetectors. The optical path may include no fibre couplers and/or fibre splitters between the sample receiving portion and the photodetectors.

Normalised spatial intensity profiles may be substantially equal at an entrance to, an exit from, or on any plane perpendicular to the optical path and within the sample receiving portion of the optical path. Normalised spatial intensity profiles may be substantially equal throughout the sample receiving portion of the optical path.

Normalised spatial intensity profiles may be considered to be substantially equal on a plane perpendicular to the path if the normalised intensity values for the first and second wavelengths are within 5%, within 10%, within 15% or within 20% of one other at each point on that plane. Normalised spatial intensity profiles may be considered to be substantially equal on a plane perpendicular to the path if the normalised intensity values for the first and second wavelengths differ, at each point on that plane, by less than two times, less than three times or less than five times the standard error of normalised intensities at the first wavelength or the second wavelength, whichever has the larger standard error.

The wavelengths corresponding to each set of light emitters may be selected in dependence upon the absorbance spectrum of one or more target analytes. The wavelength corresponding to each set of light emitters may be selected such that a target analyte has relatively higher absorbance at said wavelength than at a wavelength corresponding to each other set of light emitters. A target analyte may be any suitable labelling molecule or particles such as, for example, gold nanoparticles.

The first and second wavelengths may be selected in dependence upon the absorbance spectrum of a target analyte. The first and second wavelengths may be selected such that a target analyte has relatively higher absorbance at the first wavelength than at the second wavelength. The ratio of target analyte absorbance at the first and second wavelengths may be at least two, up to an including five, up to an including ten or more than ten. A target analyte may be any suitable labelling molecule or particles such as, for example, gold nanoparticles.

The wavelengths corresponding to each set of emitters may lie in the range between 300 nm and 1500 nm inclusive. The wavelengths corresponding to each set of emitters may lie in the range between 400 nm and 800 nm inclusive.

Each set of light emitters may include inorganic light emitting diodes. Each set of light emitters may include organic light emitting diodes. Organic light emitting diodes may be solution processed. The analytical test device may include a plurality of sets of emitters arranged to form an array. The array may include more emitters in a first direction than in a second, perpendicular direction.

The first emitters may be inorganic light emitting diodes. The first emitters may be organic light emitting diodes. The second emitters may be inorganic light emitting diodes. The second emitters may be organic light emitting diodes. The analytical test device may include a plurality of first and second emitters arranged in an array. The array may include more emitters in a first direction than in a second, perpendicular direction.

The photodetectors may take the form of photodiodes, photoresistors, phototransistors, complementary metal-oxide semiconductor (CMOS) pixels, charge coupled device (CCD) pixels, photomultiplier tubes or any other suitable photodetector. The photodetectors may take the form of organic photodiodes. Organic photodiodes may be solution processed. The analytical test device may include a plurality of photodiodes arranged in an array. The array may include more photodiodes in a first direction than in a second, perpendicular direction.

The optical path may be configured such that the photodetectors receive light transmitted through the sample receiving portion of the optical path.

The optical path may be configured such that the photodetectors receive light reflected from the sample receiving portion of the optical path.

The photodetectors may form an image sensor arranged to image all or a portion of the sample receiving portion of the optical path.

The liquid transport path may take the form of a porous medium. The porous medium may include nitrocellulose or other fibrous materials capable of transporting an aqueous liquid by capillary action, whether inherently or following appropriate surface treatments. The liquid transport path may include at least one microfluidic channel. The microfluidic channel may form a part of a microfluidic device.

The optical path may include a slit arranged before the sample receiving portion and each set of emitters may be arranged to illuminate the slit.

The optical path may include a slit arranged on the optical path before the sample receiving portion. Each first emitter and each second emitter may have a cylindrically symmetric angular emission profile, and each pair of first and second emitters may be arranged such that the slit perpendicularly bisects the pair.

Thus, equal normalised spatial intensity profiles of light at the first and second wavelengths may be provided at the sample receiving portion using a particularly simple and compact arrangement of first and second emitters.

A diffuser may be included between each set of emitters and the slit. The slit may have adjustable width. The slit may have a width between 100 μm and 1 mm inclusive. The slit may have a width between 300 μm and 500 μm inclusive. The light emitters belong to each set may have Gaussian angular emission profiles. The first and second emitters may have Gaussian angular emission profiles.

The two or more sets of emitters may include a set of second emitters, and each second emitter may be substantially transparent at the wavelengths emitted by each other set of emitters, and each other emitter may emit light into the optical path through a corresponding second emitter.

Each second emitter may be substantially transparent at the first wavelength, and each first emitter may emit light onto the optical path through a corresponding second emitter. Each second emitter may be substantially transparent at the wavelengths emitted by each first emitter and each third emitter, and wherein each first emitter and each third emitter may emit light into the optical path through a corresponding second emitter.

Thus, the optical path may be a gap between a second emitter and a photodetector. In this way, optical components such as beamsplitters, lenses, filters, monochromators or the like may be omitted.

Transparency at the wavelengths emitted by each other set of emitters may correspond to a transmittance of more than 50%, more than 75%, more than 85%, more than go % or more than 95%. Transparency at the first wavelength may correspond to a transmittance of more than 50%, more than 75%, more than 85%, more than go % or more than 95%.

The two or more sets of emitters may be arranged into an array including a plurality of pixels. Each pixel may include at least one subpixel, and each subpixel may include a light emitter corresponding to each set of emitters.

A plurality of first light emitters and a plurality of second light emitters may be arranged into an array, wherein the first and second light emitters alternate in a chessboard configuration.

Thus, the optical path may be a gap between an array of light emitters and a photodetector. In this way, optical components such as beamsplitters, lenses, filters, monochromators of the like may be omitted.

Two or three sets of emitters may be interdigitated with one another to form an array. The liquid transport path may take the form of a lateral flow type strip. The liquid transport path may take the form of the whole, a part, or at least one channel of a microfluidic device.

The controller may be further configured to intersperse illumination of each set of emitters with periods when none of the sets of emitters is illuminated.

The analytical test device may also include at least one output device.

The at least one output device may take the form of one or more light emitting diodes, and the controller may be configured to illuminate each light emitting diode in response to a corresponding value of the concentration vector exceeding a predetermined threshold.

The at least one output device may take the form of a display element, and the controller may be configured to cause the display element to display one or more outputs in response to determining the concentration vector. The controller may be configured, in response to a value of the concentration vector exceeding a predetermined threshold, to cause the display element to display a corresponding symbol or symbols. The controller may be configured to cause the display element to display one or more values of the concentration vector.

The at least one output device may take the form of a wired or wireless communications interface for connection to a data processing apparatus, and the controller may be configured to output the concentration vector to the data processing apparatus via the wired or wireless communications interface.

The controller may be configured to normalise absorbance values with respect to a reference calibration absorbance value.

The controller may be configured to illuminate the first emitters and obtain a first set of measurements using the photodetectors, to illuminate the second emitters and obtain a second set of measurements using the photodetectors, and to subtract the second set of measurements from the first set of measurements.

The controller may be configured to multiply the second set of measurements by a weighting factor before subtracting the second set of measurements from the first set of measurements.

According to a second aspect of the invention there is provided a method of operating the analytical test device. The method includes applying a liquid sample to the liquid sample receiving region of the analytical test device.

According to a third aspect of the invention there is provided a method of determining a de-convolution matrix. The method includes providing an optical path which includes a sample receiving portion. The method also includes providing a number, N, of sets of emitters, each set of emitters including one or more light emitters configured to emit light within a range around a corresponding wavelength into the optical path. At the sample receiving portion, a normalised spatial intensity profile generated by a given set of emitters is substantially equal to a normalised spatial intensity profile generated by each other set of emitters. The method also includes providing a number, N, of calibration samples. Each calibration sample includes a known concentration of N different analytes. The method also includes, for each calibration sample, arranging the calibration sample wholly or partly within the sample receiving portion of the optical path. The method also includes, for each calibration sample, sequentially illuminating each set of emitters and obtaining a corresponding measured absorbance value using the photodetectors, wherein only one set of emitters is illuminated at any time. The method also includes, for each calibration sample, generating an absorbance vector using the N measured absorbance values. The method also includes, for each calibration sample, generating a concentration vector using the N known concentrations of analytes. The method also includes generating a first N by N matrix by setting the values of each column, or each row, to be equal to the values of the absorbance vector of a corresponding calibration sample. The method also includes inverting the first matrix. The method also includes generating a second N by N matrix by setting the values of each column, or each row, to be equal to the values of the concentration vector of a corresponding calibration sample. The method also includes determining a deconvolution matrix by multiplying the second matrix by inverse of the first matrix.

Absorbance and concentration values may be normalised with respect to a reference calibration absorbance value.

A deconvolution matrix determined according to the method of determining a de-convolution matrix may be used by the controller of the analytical test device.

The method of determining a de-convolution matrix may be carried out using the analytical test device.

### BRIEF DESCRIPTION OF THE DRAWINGS

Certain embodiments of the present invention will now be described, by way of example, with reference to the accompanying drawings in which:

FIG. 1 is a schematic overview of an analytical test device including first and second light emitters;

FIGS. 2 and 3 illustrate determining first and second beam profiles corresponding to first and second emitters;

FIG. 4 illustrates normalised spatial intensity profiles generated by the first and second emitters of an analytical test device;

FIG. 5 schematically illustrates a lateral flow test strip;

FIG. 6 illustrates fibres making up a porous strip of a lateral flow test strip;

FIG. 7 illustrates a UV-visible absorbance spectrum of labelling particles used for a lateral flow test strip;

FIGS. 8 and 9 illustrate the absorbance of a lateral flow test strip as a function of position, obtained at first and second wavelengths;

FIG. 10 illustrates a correction performed by subtracting measurements at a second wavelength from measurements made at a first wavelength;

FIG. 11 is a process flow diagram for a dual wavelength measurement made using an analytical test device;

FIGS. 12 and 13 illustrate illumination timings for first and second emitters of an analytical test device;

FIG. 14 illustrates an analytical test device for transmission measurements;

FIG. 15 illustrates an analytical test device for reflectance measurements;

FIG. 16 illustrates obtaining image data using an analytical test device;

FIGS. 17 and 18 illustrate a liquid transport path which intersects an optical path of an analytical test device;

FIG. 19 illustrates a first arrangement for coupling light of first and second wavelengths into an optical path of an analytical test device;

FIGS. 20 and 21 illustrate normalised spatial intensity profiles generated by the first and second emitters of an analytical test device;

FIG. 22 illustrates a second arrangement for coupling light of first and second wavelengths into an optical path of an analytical test device;

FIG. 23 illustrates scanning a lateral flow test strip using an elongated light emitting diode array;

FIG. 24 illustrates a third arrangement for coupling light of first and second wavelengths into an optical path of an analytical test device;

FIG. 25 illustrates a portion of a first light emitting diode array for an analytical test device;

FIG. 26 illustrates a UV-visible absorbance spectrum of a second emitter of an analytical test device;

FIG. 27 illustrates a portion of a second light emitting diode array for an analytical test device;

FIG. 28 is a schematic cross-section of an analytical test device integrated into a lateral flow testing device;

FIG. 29 shows a sample produced using gold nanoparticle inks having different solution optical densities to deposit a number of test lines on a nitrocellulose strip;

FIG. 30 shows variations in the absorbance of a blank nitrocellulose strip measured at green and near infrared wavelengths;

FIG. 31 illustrates corrected absorbance measurements of a set of test lines deposited on a nitrocellulose strip;

FIGS. 32 and 33 compare the analytical test device with prior testing devices;

FIG. 34 compares the analytical test device with prior testing devices for reading a Troponin lateral flow assay;

FIG. 35 shows experimental and modelling data illustrating the influence of beam profile differences;

FIG. 36A illustrates a portion of a third light emitting diode array for an analytical test device;

FIG. 36B illustrates a portion of a fourth light emitting diode array for an analytical test device;

FIG. 37 illustrates a typical organic photodetector sensitivity profile and green, red and near infrared light emission profiles typical of organic light emitting diodes;

FIG. 38 illustrates typical absorbance profiles for gold nanoparticles, a blue dye and nitrocellulose fibres;

FIG. 39 illustrate assumed concentration profiles for gold nanoparticles, for a blue dye and for nitrocellulose fibres forming a porous strip;

FIG. 40 illustrates simulated organic photodetector signals obtained based on the data shown in FIGS. 37 to 39;

FIG. 41 illustrates filtering a simulated organic photodetector signal corresponding to a green organic light emitting diode;

FIG. 42 illustrates filtering a simulate organic photodetector signal corresponding to a near infrared organic light emitting diode;

FIGS. 43 and 44 illustrate converting normalised transmission values to absorbance values;

FIGS. 45 and 46 illustrate estimating absorbance fingerprint values corresponding to gold nanoparticles and nitrocellulose fibres;

FIG. 47 illustrates analysing a three component simulated system using first and second wavelengths;

FIG. 48 illustrates analysing a three component simulated system using first, second and third wavelengths;

FIG. 49 illustrates a portion of a third light emitting diode array for an analytical test device; and

FIG. 50 illustrates a portion of a fourth light emitting diode array for an analytical test device.

### DETAILED DESCRIPTION OF CERTAIN EMBODIMENTS

If the number and complexity of optical components in a quantitative detector could be reduced, then the size and cost of the detector could be reduced. This would be of particular advantage for handheld or portable testing devices, and for single use home testing kits.

The minimum threshold for detecting an analyte may be improved if the signal to noise ratio of the measurement could be improved. Additionally, improvements in the signal to noise ratio may also allow for an analyte concentration to be determined with improved resolution.

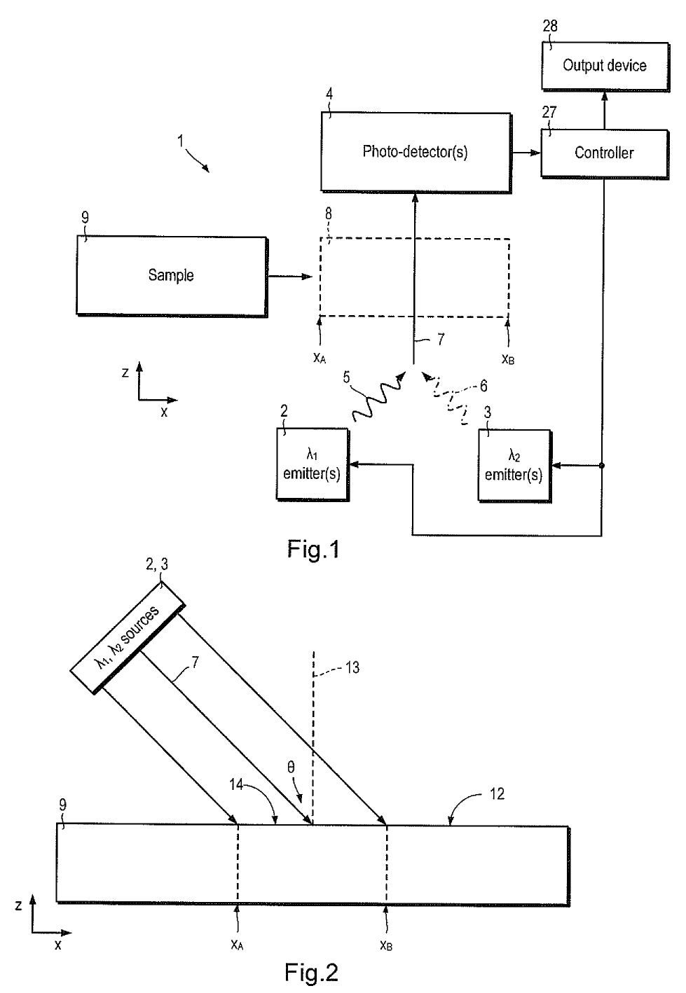

Referring to FIG. 1, an analytical test device 1 includes one or more first light emitters 2, one or more second light emitters 3 and one or more photodetectors 4.

Each first light emitter is configured to emit light 5 within a range around a first wavelength λ₁, and each second light emitter is configured to emit light 6 within a range around a second wavelength λ₂. The first light emitter(s) 2 may take the form of, for example, organic or inorganic light emitting diodes. Similarly, the second light emitter(s) 3 may take the form of, for example, organic or inorganic light emitting diodes. Organic light emitting diodes may be solution processed. If the first light emitter(s) 2 take the form of organic light emitting diodes, the second light emitter(s) need not take the form of organic light emitting diodes and vice versa. The analytical test device may include a plurality of first and second light emitters 2, 3 arranged in an array. The array may include more light emitters 2, 3 in a first direction than in a second, perpendicular direction.

The one or more photodetector(s) are sensitive across a broad wavelength range which includes at least the first and second wavelengths λ₁, λ₂. The photodetector(s) 4 may take the form of, for example, photodiodes, photoresistors, phototransistors, complementary metal-oxide semiconductor (CMOS) pixels, charge coupled device (CCD) pixels, photomultiplier tubes or any other suitable photodetector. Photodiodes may be organic or inorganic. Organic photodiodes may be solution processed. The analytical test device 1 may include a plurality of photodetectors 4 arranged in an array. The array may include more photodetectors in a first direction y than in a second, perpendicular direction x.

The first and second light emitters 2, 3 are each coupled to an optical path 7 along which the light 5, 6 travels to reach the photodetector(s) 4. The optical path 7 includes a sample receiving portion 8. The analytical test device 1 is arranged to receive a sample 9. When a sample 9 is received into the analytical test device 1, the sample, or at least a portion of the sample 9, intersects the sample receiving portion 8 of the optical path 7.

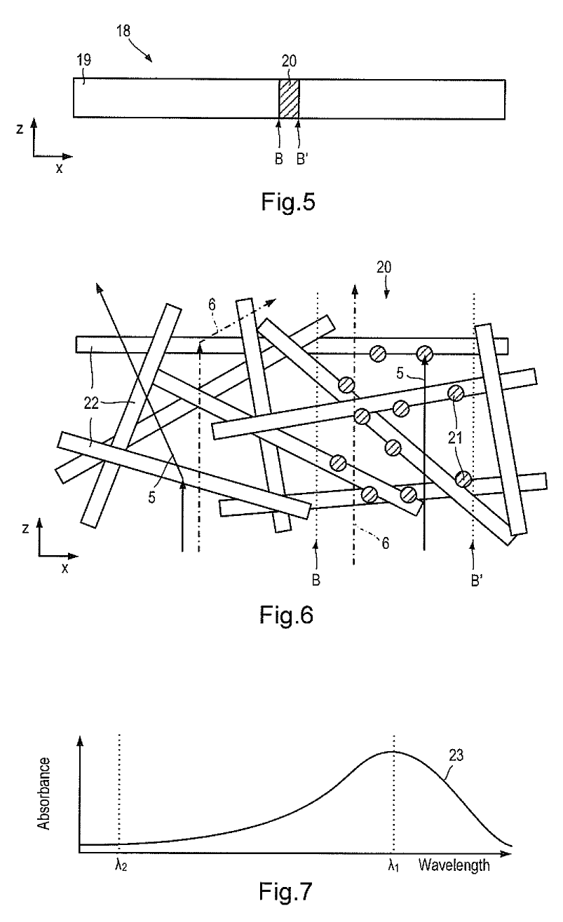

The sample receiving portion 8 of the optical path 7 may be configured to receive a sample 9 in the form of a lateral flow test strip 18 (FIG. 5), or a microfluidic device. When the analytical test device 1 is integrated into a lateral flow or microfluidic test, the sample 9 may be already positioned within the sample receiving portion of the optical path 7 before the assay is commenced.

The first light emitter(s) 2 and the second light emitter(s) 3 are alternately illuminable. Illumination of the first and second light emitters 2, 3 may be interspersed with periods when neither of the first and second light emitters 2, 3 is illuminated. A period between turning off the first light emitter(s) 2 and illuminating the second light emitter(s) 3 can be used for detecting fluorescence excited by the light 5 from the first light emitter(s) 2. Similarly, fluorescence excited by light 6 from the second light emitter(s) 3 may be detected during a period after turning off the second light emitter(s) and before turning on the first light emitter(s) 2.

The analytical test device 1 also includes a controller 27. The controller 27 is configured to sequentially illuminate the first and second emitters 2, 3 and to obtain corresponding measured absorbance values using the photodetectors 4. Only one set of emitters 2, 3 is illuminated at any time. The controller 27 is also configured to generate an absorbance vector using the measured absorbance values, and to determine a concentration vector by multiplying the absorbance vector with a de-convolution matrix as described hereinafter. The controller may optionally be configured to intersperse illumination of each set of emitters with periods when none of the sets of emitters is illuminated. The controller 27 may be configured to normalise absorbance so values with respect to a reference calibration absorbance value.

In the particular case of first and second emitters 2, 3, the controller 27 may be configured to illuminate the first emitters 2 and obtain a first set of measurements using the photodetectors 4, to illuminate the second emitters 3 and obtain a second set of measurements using the photodetectors 4, and to subtract the second set of measurements from the first set of measurements, a s further described hereinafter. The controller may be configured to multiply the second set of measurements by a weighting factor before subtracting the second set of measurements from the first set of measurements. Further details of the methods, processes and calculations carried out by the controller 27 are described hereinafter.

The analytical test device 1 also includes at least one output device 28. For example, the output device 28 may take the form of one or more light emitting diodes which are arranged for viewing by a user of the analytical test device 1. The controller 27 may be configured to illuminate each light emitting diode in response to a concentration of a specific analyte vector exceeding a predetermined threshold.

In a further example, the output device 28 may take the form of a display element. The controller may be configured to cause the display element to display one or more outputs in response to determining the concentrations of one or more analytes. The controller may be configured, in response to a determined concentration of an analyte exceeding a predetermined threshold, to cause the display element to display a corresponding symbol or symbols. The controller may be configured to cause the display element to display the determined concentrations of one or more analytes.

In another example, the at least one output device 28 may take the form of a wired or wireless communications interface for connection to a data processing apparatus (not shown). The data processing apparatus may take the form of, for example, a mobile telephone, tablet computer, laptop, desktop or a server. The controller may be configured to output the measured concentrations of one or more analytes to the data processing apparatus (not shown) via the wired or wireless communications interface.

Referring also to FIGS. 2 to 4, the first and second light emitters 2, 3 and the optical path 7 are arranged so that a normalised beam profile 10 of light 5 from the first emitter 2 is substantially equal to a normalised beam profile 11 of light 6 from the second emitter 3.

For example, referring in particular to FIG. 2, light 5, 6 introduced into the optical path 7 intersects a sample surface 12 in a first direction x between first and second locations x_{A}, x_{B}. Likewise, light 5, 6 introduced into the optical path 7 intersects the sample surface 12 in a second, perpendicular direction y between first and second locations y_{A}, y_{B}. For example, the sample surface 12 may be a surface of a lateral flow test strip or a surface of a substrate containing/defining microfluidic channels. The optical path 7 makes an angle θ with the normal 13 to the sample surface 12. The positions x_{A}, x_{B}, y_{A}, y_{B} bound a notional surface 14 of the sample receiving portion 8 which approximately corresponds to the sample surface 12 in use. When the analytical test device 1 is integrated into a lateral flow or microfluidic test, the notional surface 14 may be coincident with a surface of a lateral flow test strip or a surface of a substrate containing/defining microfluidic channels. The angle θ is greater than or equal to 0 degrees and less than 90 degrees. The normal 13 is oriented with respect to the sample surface 12 on average, rather than a local normal which can vary significantly from point to point due to surface roughness and/or localised inhomogeneity. The optical path 7 may be converging or diverging, i.e. the light 5,6 may form a converging or diverging beam, in which case θ is the angle between a central ray/centre of the optical path 7 and the normal 13.

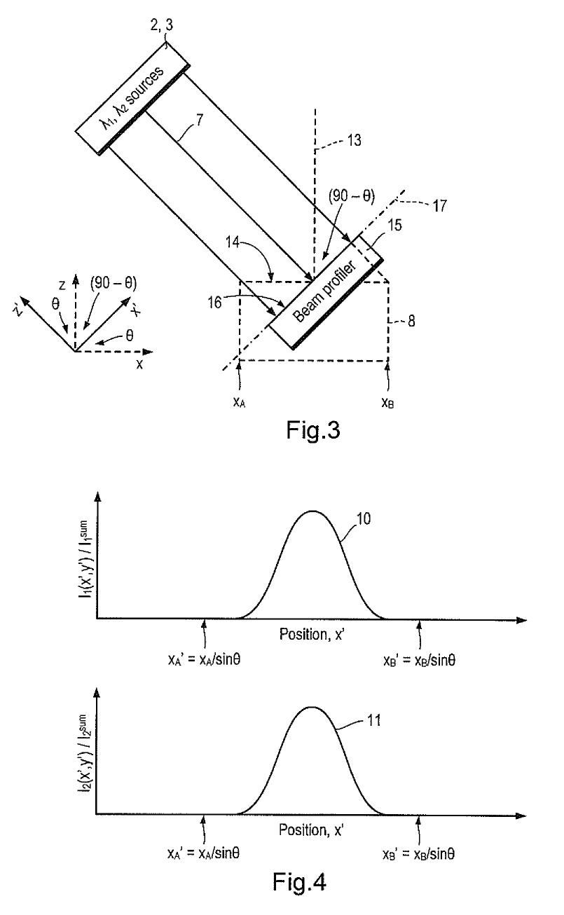

Referring in particular to FIG. 3, the normalised beam profiles of light 5, 6 from the first and second emitters 2, 3 may be obtained using a beam profiler 15. The beam profiler 15 is arranged to intersect the optical path 7 in the absence of a sample 9. The beam profiler 15 is arranged at the position where the optical path 7 intersects the notional surface 14 of the sample receiving portion 8 of the optical path 7. The beam profiler 15 is arranged so the centre of the beam profiler 15 corresponds as closely as is practical to the centre of the optical path 7. The beam profiler 15 is arranged with a detection surface 16 oriented perpendicular to the optical path 7, or at least to a centre of the optical path 7. In other words, the beam profiler 15 is rotated by an angle of θ compared to the notional surface 14 of the sample receiving portion 8. In this way, the beam profiler 15 measures the beam profile intensities 10, 11 in a measurement plane 17 which is transverse to the optical path 7 (or the centre thereof). A line of common intersection between the optical path 7, the notional surface 14 of the sample receiving portion 8 and the measurement plane 17 defines the measurement location. When a sample 9 is received into the sample receiving portion 8, the line of common intersection will approximately correspond to the sample surface 12, with deviations depending on the regularity of the sample 9 and the accuracy of placing the sample 9.

The beam profiler 15 measures light 5, 6 intensities in a measurement plane 17 which is rotated by an angle θ about the second direction y with respect to the notional surface 14. Positions on the notional surface 14, for example the bounds x_{A}, x_{B}, y_{A}, y_{B} of the notional surface 14 of the sample receiving portion 8, are projected onto positions x_{A}′, x_{B}′, y_{A}′, y_{B}′ on the measurement plane 17 according to x_{A}′=x_{A}/sin θ, x_{B}′=x_{B}/sin θ, y_{A}′=y_{A} and y_{B}′=y_{B}. Preferably, a light sensitive area of the beam profiler 15 detection surface 16 is large enough to encompass the projected bounds x_{A}′, x_{B}′, y_{A}′, y_{B}′ of the notional surface 14.

Referring in particular to FIG. 4, the intensity of light from the first light emitter(s) 2 is denoted I₁(x′,y′) on the x′-y′ measurement plane 17. The normalised spatial intensity profile 10 generated by the first light emitter(s) 2 (herein also referred to as the first beam profile 10) may be defined as the ratio of the intensity of light from the first light emitter(s) 2 divided by the summed intensity I₁^{sum} detected by the beam profiler 15, i.e. I₁(x′,y′)/I₁^{sum}. The normalised spatial intensity profile 11 generated by the second light emitter(s)₃ (herein also referred to as the second beam profile 11) is defined in the same way as I₂(x′,y′)/I₂^{sum}.

The first and second beam profiles 10, 11 are preferably substantially equal on the measurement plane 17, i.e. on entering the sample receiving portion 8. Preferably, the normalised spatial intensity profiles 10, 11 are substantially equal throughout the sample receiving portion 8 of the optical path 7. However, uniformity throughout the sample receiving portion 8 is not necessary since, in use, the scattering from the sample 9 will be more significant than effects of diverging beam profiles 10, 11.

A number of difference metrics may be used to quantify the extent of differences between the first and second beam profiles 10, 11. For example, a maximum beam profile difference Δₘₐₓ may be defined according to:

$${Δ}_{max} = max ( \vert \frac{{I}_{1} ( {x}^{′} , {y}^{′} )}{{I}_{1}^{sum}} - \frac{{I}_{2} ( {x}^{′} , {y}^{′} )}{{I}_{2}^{sum}} \vert ) \qquad ( 1 )$$

Similarly, an average beam profile difference Δ_{avg} may be defined according to:

$${Δ}_{avg} = \frac{{{\int }^{{y}_{B}^{′}}}_{{y}_{A}^{′}} {{\int }_{{x}_{A}^{′}}}^{{x}_{B}^{′}} \vert \frac{{I}_{1} ( {x}^{′} , {y}^{′} )}{{I}_{1}^{sum}} - \frac{{I}_{2} ( {x}^{′} , {y}^{′} )}{{I}_{2}^{sum}} \vert {dx}^{′} {dy}^{′}}{( {x}_{B}^{′} - {x}_{A}^{′} ) \times ( {y}_{B}^{′} - {y}_{A}^{′} )} \qquad ( 2 )$$

If the output of the beam profiler 15 is an array of intensities corresponding to an array of positions x′, y′, the integral defined in Equation 2 may be readily converted to a sum in order to determine the average beam profile difference Δ_{avg}.

Alternatively, a root-mean-square (RMS) difference Δ_{RMS} may be defined according to:

$${Δ}_{RMS} = \sqrt{\frac{{{\int }^{{y}_{B}^{′}}}_{{y}_{A}^{′}} {{\int }_{{x}_{A}^{′}}}^{{x}_{B}^{′}} {( \frac{{I}_{1} ( {x}^{′} , {y}^{′} )}{{I}_{1}^{sum}} - \frac{{I}_{2} ( {x}^{′} , {y}^{′} )}{{I}_{2}^{sum}} )}^{2} {dx}^{′} {dy}^{′}}{( {x}_{B}^{′} - {x}_{A}^{′} ) \times ( {y}_{B}^{′} - {y}_{A}^{′} )}} \qquad ( 3 )$$

If the output of the beam profiler 15 is an array of intensities corresponding to an array of positions x′, y′, the integral defined in Equation 3 may be converted to a sum to determine the average beam profile difference Δ_{avg}. Difference metrics are not limited to the maximum, average and/or RMS beam profile differences Δₘₐₓ, Δₘₑₐₙ, Δ_{RMS}) and alternative difference metrics may be defined to quantify the extent of differences between the first and second beam profiles 10, 11.

The first and second emitters 2, 3 and the optical path 7 are arranged such that the first and second beam profiles 10, 11 are substantially equal on the measurement plane 17. The following description shall refer to an example in which light 5 from the first emitter 2 is used to quantify the sample 9, whilst light 6 from the second emitter 3 is used as a reference (as explained hereinafter). However, the same principles are applicable if light 6 from the second emitter 3 is used to quantify the sample 9, whilst light 5 from the first emitter 2 is used as a reference.

The beam profiles 10, 11 may be considered to be substantially equal when the maximum difference Δₘₐₓ, average difference Δ_{avg} or RMS difference Δ_{RMS} are less than or equal to an absolute threshold determined by prior experiments. Preferably, whether or not the beam profiles 10, 11 may be considered to be substantially equal can be evaluated by comparing the maximum difference Δₘₐₓ average difference Δ_{avg} or RMS difference Δ_{RMS} to a relative threshold determined from the beam profiles 10, 11 themselves.

For example, a first threshold may be based on a fraction of the maximum normalised intensity of light 5 from the first emitter 2, i.e. I₁^{max}=max(I₁(x′,y′)). The first and second beam profiles 10, 11 may be considered to be substantially equal if the maximum Δₘₐₓ, average Δ_{avg} or RMS difference Δ_{RMS} is less than or equal to 0.05×I₁^{max} (≤5%), less than or equal to 0.1×I₁^{max} (≤10%), less than or equal to 0.2×I₁^{max} (≤20%) or less than or equal to 0.5×I₁^{max} (≤50%).

In an ideal case, the first and second beam profiles are equal to each other at each point, i.e. for all x′, y′ measured by the beam profiler 15. In practice, an alternative determination of whether the first and second beam profiles are sufficiently similar to be regarded as substantially equal may be performed using the inequality:

$$\vert \frac{{I}_{1} ( {x}^{′} , {y}^{′} )}{{I}_{1}^{sum}} - \frac{{I}_{2} ( {x}^{′} , {y}^{′} )}{{I}_{2}^{sum}} \vert \leq f \times \frac{{I}_{1} ( {x}^{′} , {y}^{′} )}{{I}_{1}^{sum}} \qquad ( 4 )$$

In which 0≤f≤0.5 is a fraction. For example, a value of f=0.1 corresponds to testing whether the difference between first and second beam profiles 10, 11 is less than or equal to 10% of the first beam profile 10. In one example, the first and second beam profiles 10, 11 may be considered to be substantially equal if the inequality of Equation (4) is satisfied for all x_{A}′≤x′≤x_{B}′ and all y_{A}′≤y′≤y_{B}′. Alternatively, the first and second beam profiles 10, 11 may be considered to be substantially equal if the inequality of Equation (4) is satisfied for a threshold percentage of the area measured by the beam profiler 15, for example, if the inequality of Equation (4) is satisfied for greater than or equal to 90%, greater than or equal to 75% or greater than or equal to 50% of the measured area.

The beam profiler 15 may be any suitable form of beam profiler such as, for example, a camera based beam profiler, a translating slit beam profiler, a translating step beam profiler and so forth. The relative sensitivity of the beam profiler 15 to different wavelengths need not be the same at the first and second wavelengths λ₁, λ₂, since any difference should be compensated for through the use of relative spatial intensities. Filters are not required in order to determine the beam profiles 10, 11, since the first and second emitters 2, 3 are independently illuminable.

A signal obtained using the second light emitter(s) may be subtracted from a signal obtained using the first emitter(s) in order to compensate for optical scattering due to defects or other inhomogeneities in a medium, or substrate which forms part of the sample 9. The subtraction is carried out by the controller 27.

Referring also to FIG. 5, a lateral flow test strip 18 is an example of a sample 9 which may be measured using the analytical test device 1.

Lateral flow test strips 18 (also known as “lateral flow immunoassays”) are a variety of biological testing kit. Lateral flow test strips 18 may be used to test a liquid sample, such as saliva, blood or urine, for the presence of an analyte. Examples of lateral flow devices include home pregnancy tests, home ovulation tests, tests for other hormones, tests for specific pathogens and tests for specific drugs.

In a typical lateral flow test strip 18, a liquid sample is introduced at one end of a porous strip 19, and the liquid sample is then drawn along the lateral flow test strip 18 by capillary action (or “wicking”). A portion of the lateral flow strip 18 is pre-treated with labelling particles 21 (FIG. 6) which are activated with a reagent which binds to the analyte to form a complex if the analyte is present in the liquid sample. The bound complexes, and also unreacted labelling particles 21 (FIG. 6) continue to propagate along the lateral flow test strip 18 before reaching a testing region 20 which is pre-treated with an immobilised binding reagent which binds complexes of analyte bound to labelling particles 21 (FIG. 6) and does not bind unreacted labelling particles 21 (FIG. 6). The labelling particles 21 (FIG. 6) have a distinctive colour, or otherwise absorb one or more ranges of ultraviolet or visible light. The development of a concentration of labelling particles 21 (FIG. 6) in the test region 20 may be measured and quantified using the analytical test device 1, for example by measuring the optical density of labelling particles 21 (FIG. 6). The analytical test device 1 may perform measurements on developed lateral flow test strips 18, i.e. the liquid sample has been left for a pre-set period to be drawn along the test strip 18. Alternatively, the analytical test device 1 may perform kinetic, i.e. dynamic time resolved measurements of the optical density of labelling particles 21 (FIG. 6).

Referring also to FIG. 6, the porous strip 19 is typically formed from a mat of fibres 22, for example nitrocellulose fibres. Within the test region 20, the immobilised binding reagent binds complexes of analyte and labelling particles 21.

The fibres 22 scatter and/or absorb light across a broad range of wavelengths in an approximately similar way. For example, the proportion of light 5 from the first light emitter(s) 2 which is scattered by fibres 22 is approximately the same as the proportion of light 6 from the second light emitter(s) 3. However, the fibrous porous strip 19 is not uniform, and the density of fibres 22 may vary from point to point along the porous strip 19. As explained further hereinafter, such background variations of absorbance, which are due to the inhomogeneity of the porous strip 19, may limit the sensitivity of a measurement, i.e. the minimum detectable concentration of labelling particles 21.

Referring also to FIG. 7, the analytical test device 1 may compensate for such background variations of absorbance due to the inhomogeneity of the porous strip 19, provided that the first and second wavelengths λ₁, λ₂ are selected appropriately for the labelling particles 21 used for a lateral flow test strip 18. For example, an ultraviolet-visible spectrum 23 of the labelling particles 21 may be obtained to determine how the absorbance of the labelling particles 21 varies with wavelength/frequency. The first wavelength A, is selected to be a wavelength which is at, or close to, a peak absorbance of the labelling particles 21. The second wavelength λ₂ is selected to be a wavelength which lies substantially away from a peak absorbance of the labelling particles 21. In other words, the first and second wavelengths λ₁, λ₂ are selected such that labelling particles have relatively higher absorbance at the first wavelength λ₁ than at the second wavelength λ₂. The ratio of absorbance between the first and second wavelengths λ₁, λ₂ may be a factor of, for example, at least two, up to and including five, up to and including ten, or more than ten.

The first and second wavelengths λ₁, λ₂ may lie in the range between 300 nm and 1500 nm inclusive. The first and second wavelengths λ₁, λ₂ may lie in the range between 400 nm and 800 nm inclusive.

Referring in particular to FIG. 6, light 5 from the first light emitter(s) 2, having wavelengths around the first wavelength λ₁, is absorbed by the labelling particles 21, in addition to being scattered and/or absorbed by the fibres 22. By contrast, light 6 from the second light emitter(s) 3, having wavelengths around the second wavelength λ₂, is absorbed by the labelling particles 21 only weakly or not at all.

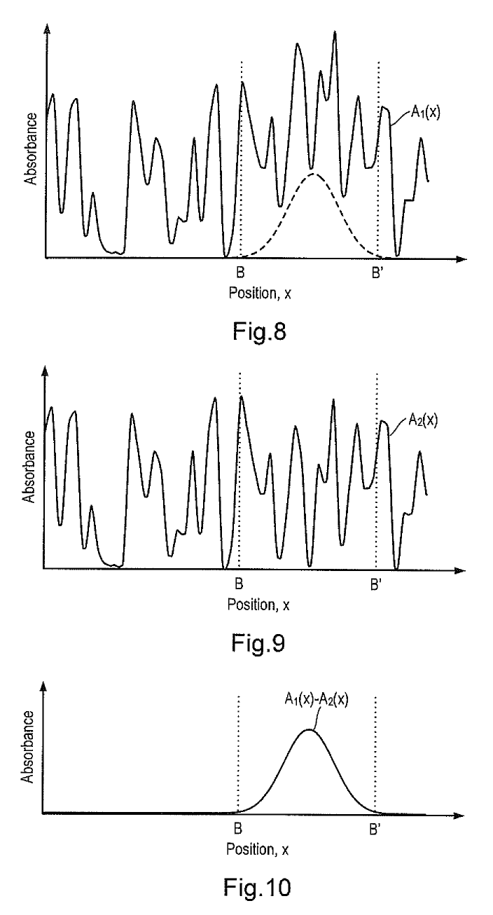

Referring also to FIGS. 8 to 10, a lateral flow test strip 18 may be passed through the sample receiving portion 8 of the optical path 7, and the absorbance values A(x) measured as a function of position x along the porous strip 19 of the lateral flow testing device 18. The absorbance values A(x) are determined based on the difference in transmittance or reflectance when a sample 9 occupies the sample receiving portion 8 and a reference condition, for example, the absence of a sample 9.

The absorbance A₁(x) at the first wavelength X, and the absorbance A₂(x) at the second wavelength λ₂ have substantially equal contributions from scattering and/or absorption by the fibres 22 of the porous strip 19. The background level of absorbance varies with position x along the porous strip 19 due to the inhomogeneity of fibre 22 density. Absorbance signals resulting from the labelling particles 21 cannot be reliably detected unless they are at least larger than the background variance which results from inhomogeneity of the porous strip 19. This restricts the lower limit of labelling particle concentration which can be detected using a lateral flow test strip 18. The same background variance also limits the resolution of a quantitative measurement of labelling particle 21 concentration/optical density.

However, since the fibres 22 scatter light at the first and second wavelengths λ₁, λ₂ in approximately the same way, the absorbance values A₂(x) values at the second wavelength λ₂ may be subtracted from the absorbance values A₁(x) at the first wavelength λ₁ to reduce or remove the effect of the variations in background absorbance which result from the inhomogeneous distribution of fibres 22 in the porous strip.

Although in practice some amount of background variance in absorbance will remain when the difference A₁(x)-A₂(x) is obtained, the relative size of the signal which is specific to the labelling particles 21 may be increased, in some cases substantially, with respect to background variations. In this way, the lower limit of labelling particle 21 concentrations/optical densities which may be detected may be reduced. Similarly, the resolution of a quantitative measurement of labelling particle 21 concentration/optical density may be increased.

Although the normalised spatial intensity profiles, i.e. first and second beam profiles 10, 11 generated by the first and second light emitter(s) are preferably substantially equal for the correction to be effective (as described hereinbefore), the absolute spatial intensity profiles (not shown) need not be equal.

When the absolute intensities of light 5, 6 from the first and second light emitters 2, 3 are not equal, the intensity ratio α of the first and second light emitters 2, 3 may be measured in the absence of a sample 9 and used to perform a weighted correction, i.e. A₁(x)-αA₂(x). Alternatively, the weighting factor α may account for differing sensitivity of the photodetector(s) 4 at the first and second wavelengths λ₁, λ₂.

Through alternately illuminating the first and second emitters 2, 3, the analytical test device 1 may include a relatively simple optical path 7 which does not require optical components such as beamsplitters, filters or monochromators to perform dual-wavelength measurements. Thus, the analytical test device 1 may be less bulky, simpler and less expensive to manufacture. Additionally, many optical components such as beamsplitters have wavelength dependent properties, which may restrict the choice of wavelengths λ₁, λ₂. By reducing the number of optical components in the optical path 7, or in some examples removing the need for intermediate optical components altogether, the wavelengths λ₁, λ₂ for a dual-wavelength measurement may be less constrained.

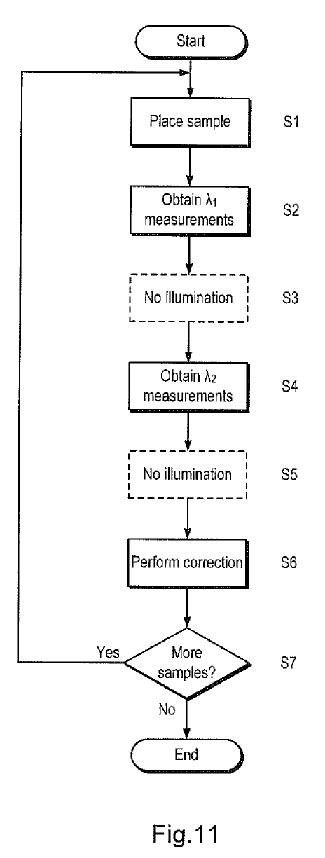

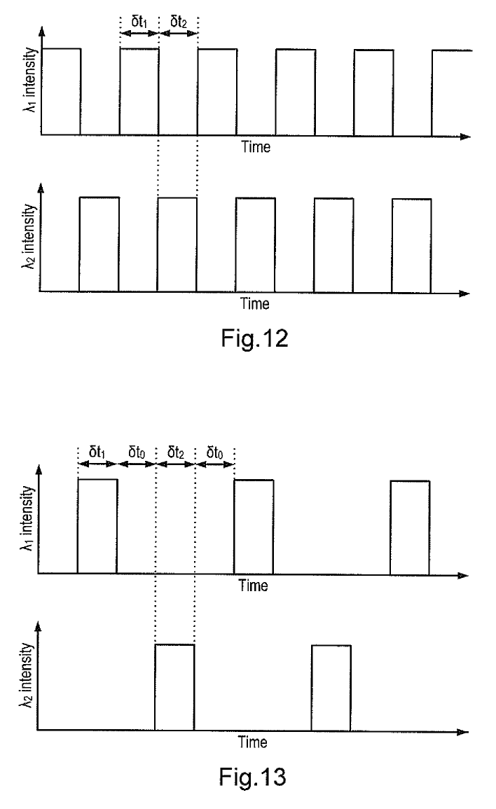

Referring also to FIGS. 11 to 13, a process of obtaining and correcting absorbance measurements will be described. The process described with reference to FIGS. 11 to 13 may be carried out by the controller 27 of the analytical test device 1.

A sample 9 is placed so that a region of interest on the sample 9 coincides with the sample receiving portion 8 of the optical path 7 (step S1). When the analytical test device 1 is integrated in a self-contained assay including a lateral flow strip or a microfluidic device, this stage may be omitted. The first light emitter(s) 2 are turned on for a period of duration δt₁, and the photodetector(s) 4 measure the light 5 transmitted through (or reflected from) the sample receiving portion 8 of the path (step S2). Optionally, the first light emitter(s) 2 may be switched off for a period of duration δt₀, so that the photodetector(s) 4 may also measure fluorescence excited by the light 5 from the first light emitter(s) 2 (step S3).

The second light emitter(s) 3 are turned on for a period of duration δt₂, and the photodetector(s) 4 measure the light 6 transmitted through (or reflected from) the sample receiving portion 8 of the path (step S4). Optionally, the second light emitter(s) 3 may be switched off for a period of δt₀, so that the photodetector(s) 4 may also measure fluorescence excited by the light 6 from the second light emitter(s) 2 (step S5).

The absorbance values A₂(x) determined using the second light emitter(s) 3 are subtracted to correct the absorbance values A₁(x) determined using the first light emitter(s) 2 according to A₁(x)-αA₂(x), in which a is a weighting factor to account for differences in the absolute intensity of illumination between the first and second wavelengths λ₁, λ₂ and/or differing sensitivity of the photodetector(s) 4 at the first and second wavelengths λ₁, λ₂ (step S6).

Alternatively, for measurements in transmission, a simple calculation may be performed by dividing the transmission of the light 5 from the first emitter 2 by the transmission of the light 6 from the second emitter 3.

If further samples 9 are to be measured, then the next sample 9 may be placed (step S7). Alternatively, if there are additional regions of interest on the same sample 9, for example if the sample 9 is a lateral flow test strip 18 having more than one test region 20, the sample 9 may be repositioned with the next region of interest within the sample receiving portion 8.

The periods δt₁ and δt₂ may lie in a range between, for example, 10 ms and 500 ms inclusive.

### Measurement Geometries

The analytical test device 1 may be configured to use a range of emitter 2, 3 and photodetector 4 geometries.

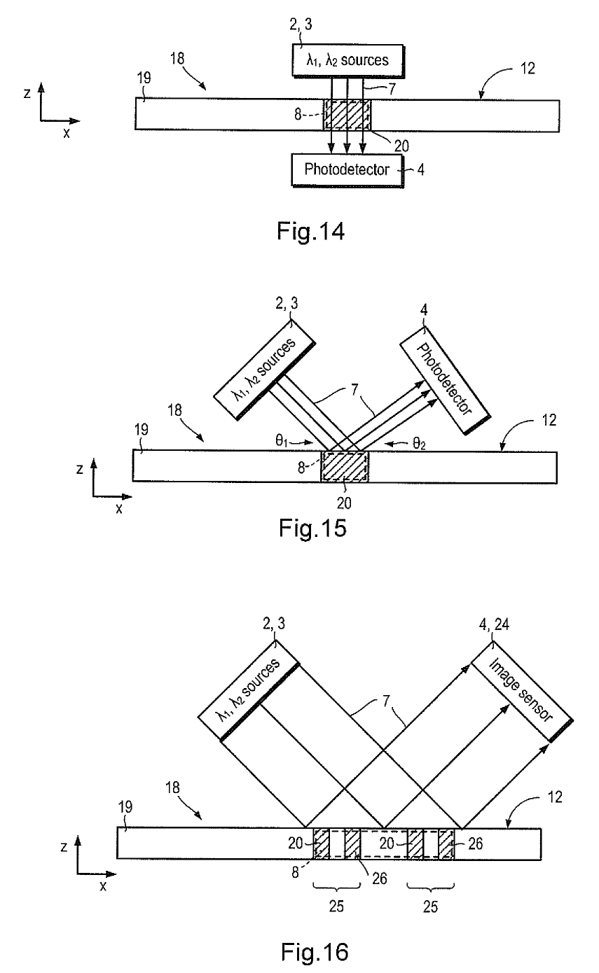

Referring also to FIG. 14, the optical path 7 may be configured so that the photodetector(s) 4 receive light 5, 6 transmitted through the sample receiving portion 8 of the optical path 7. For measurements in transmission, the light emitter(s) 2, 3 and photodiode(s) 4 may simply be spaced apart by a gap which corresponds to the optical path 7. The sample receiving portion 8 of the optical path 7 then corresponds to the part of the gap which is occupied by a sample 9 when the sample 9 is received into the analytical testing device 1.

For example, if a sample 9 in the form of a lateral flow test strip 18 is used, the lateral flow test strip 18 may be arranged with a testing region 20 positioned between the light emitter(s) 2, 3 and photodiode(s) 4. The sample receiving portion 8 of the path 7 corresponds to the thickness of the lateral flow test strip 18 which intersects the optical path 7.

Additional optical components may be included in the optical path 7. For example, the light from the light emitters 2, 3 into the optical path 7 and/or the light from the optical path 7 to the photodiode(s) 4 may be restricted by slits or other apertures. Optionally, a diffuser, one or more lenses and/or other optical components may also be included in the optical path 7.

Referring also to FIG. 15, an analytical test device 1 may alternatively be configured so that the photodetector(s) 4 receive light reflected from the sample receiving portion 8 of the optical path 7. For example, when the analytical testing device 1 is arranged to receive samples in the form of lateral flow test strips 18, the light emitters 2, 3 may be arranged to illuminate a region of interest of a lateral flow test strip 18 received into the test device 1 at first angle θ₁, and the photodiode(s) 4 may be arranged to receive light reflected from the lateral flow test strip 18. Light reflected from the porous strip 19 of a lateral test strip 18 will, in general, be scattered into a wide range of different angles due to the largely random orientations of the fibres 22. Consequently, the portion of the optical path 7 between the sample receiving region 8 and the photodetector(s) 4 may be oriented at a second angle θ₂, which does not need to be equal to the first angle θ₁. In some examples, the first and second angles θ₁, θ₂ may be equal. In some examples, the light emitters 2, 3 and photodetector(s) 4 may be arranged in a confocal configuration. Light reflected from the sample 9 may originate from the sample surface 12 or from a depth within the sample 9.

Additional optical components may be included in the optical path 7. For example, the light from the light emitters 2, 3 into the optical path 7 and/or the light from the optical path 7 to the photodiode(s) 4 may be restricted by slits or other apertures. Optionally, a diffuser, one or more lenses and/or other optical components may also be included in the optical path 7.

Referring also to FIG. 16, the analytical test device 1 may include a number of photodetectors 4 arranged in an array to form an image sensor 24. For example, the image sensor 24 may form part of a camera. An image sensor 24 may be arranged to image all of, or a portion of, the sample receiving portion 8 of the optical path 7. For example, when a lateral flow test strip 18 is received into an analytical test device 1, the image sensor 24 may be arranged to image one or more test regions 20 and the surrounding areas of the porous strip 19. A lateral flow test strip 18 may include one or more pairs 25, each pair 25 including a testing region 20 and a control region 26, and the image sensor 24 may be arranged to image the one or more pairs 25 at the same time. An image captured using the second, reference wavelength λ₂ may be subtracted from an image captured using the first, measurement wavelength λ₁, in order to compensate for background variance due to inhomogeneity of the fibres 22 making up the porous strip 19. The subtraction may be weighted using a weighting factor α when the absolute intensity of illumination from the first and second emitters 2, 3 is not substantially equal and/or when the sensitivity of the image sensor 24 differs between the first and second wavelengths λ₁, λ₂.

An image sensor 24 may be used to image transmitted or reflected light. Additional optical components may be included in the optical path 7. For example, the light from the light emitters 2, 3 into the optical path 7 and/or the light from the optical path 7 to the photodiode(s) 4 may be restricted by slits or other apertures. Optionally, a diffuser, or more lenses and/or other optical components may also be included in the optical path 7.

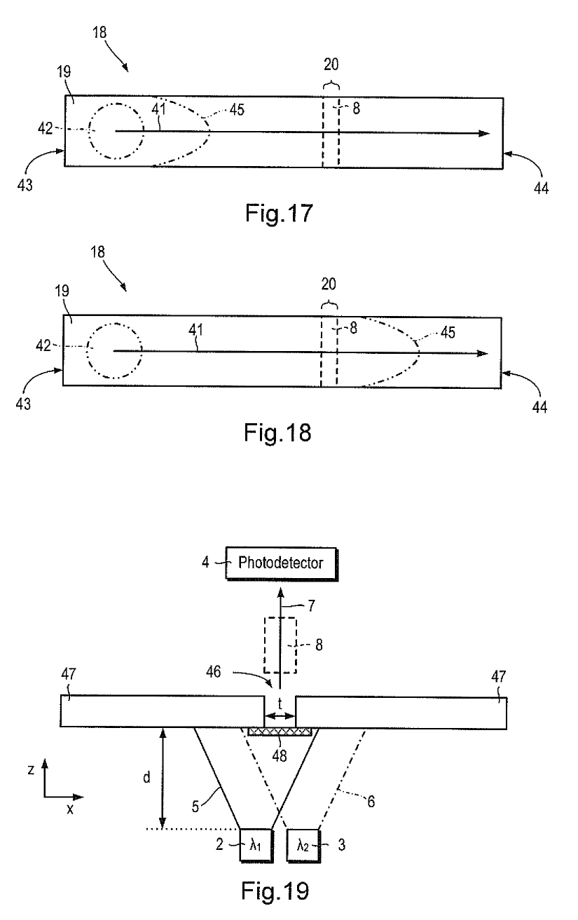

Referring also to FIGS. 17 and 18, the analytical test device 1 may also include a liquid transport path 41 for transporting a liquid sample received in a liquid sample receiving region 42 proximate to a first end 43 of the liquid transport path 41 towards a second end 44 of the liquid transport path 41. The liquid transport path 41 intersects the sample receiving portion 8 of the optical path 7.

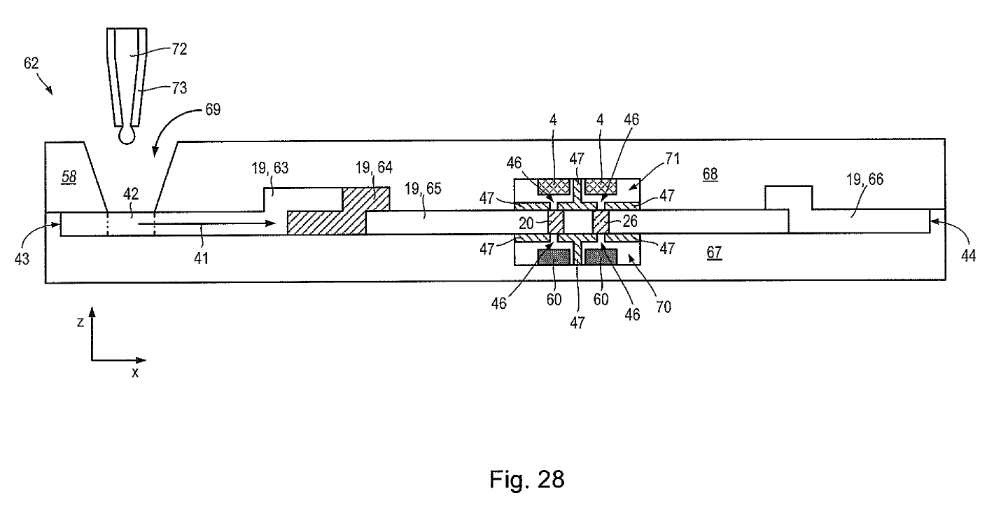

The liquid transport path 41 may take the form of a porous medium, for example the porous strip 19 of a lateral flow test strip 18. The porous strip 19 may include nitrocellulose or other fibrous materials capable of transporting an aqueous liquid by capillary action. The porous strip 19 may be inherently capable of drawing liquid along the liquid transport path 41 by capillary action. Depending on the fibres used, surface treatments may be performed to permit, or enhance, the transport of liquid along the liquid transport path 41. When the liquid transport path 41 takes the form of a porous strip 19, dry and wet portions of the porous strip are separated by a flow front 45 which propagates along the liquid transport path 41. Even once the flow front 45 has reached the second end, 44, liquid may continue to flow along the liquid transport path 41 if the second end 44 is in contact with a reservoir or wicking pad 66 (FIG. 28).

The liquid transport path 41 intersects the sample receiving portion 8 of the optical path 7 and the optical absorbance of the porous strip 19 in the sample receiving portion may be monitored as a function of time. Such measurements may sometimes be referred to as “dynamic” or “kinetic” measurements. For example, if a lateral flow test strip 18 is arranged with a test region 20 within the sample receiving portion 8, then the development of the concentration of labelling particles 21 may be tracked as a function of time by measuring the absorbance of the test region 20 at the first and second wavelengths λ₁, λ₂ as a function of time. If a lateral flow test strip 18 includes additional regions of interest, for example control regions 26 or further test regions 20, then the analytical test device 1 may be provided with additional pairs of emitters 2, 3 and photodetector(s) 4.

The liquid transport path 41 need not be a porous strip 19 of a lateral flow test strip 18. Alternatively, the liquid transport path 42 may take the form of one or more channels of a microfluidic device.

In this way, dynamic information about the development of an assay may be obtained. Dynamic information may be useful, for example, to check that an assay has behaved as expected or within acceptable bounds for a result to be considered reliable. The intervals δt₁, δt₂ and, if used, δt₀, should be relatively short compared to the timescales on which an assay is developed.

### Coupling the First and Second Emitters to the Optical Path

There are several different ways to introduce light 5, 6 from the first and second emitters 2, 3 onto the optical path 7 so that the corresponding normalised spatial intensity profiles 10, 11 are substantially equal in the sample receiving portion 8 of the optical path 7.

For example, referring also to FIG. 19, light 5, 6 from the first and second emitters 2, 3 may be introduced onto the optical path 7 through a slit 46 defined by a pair of slit members 47 separated by a gap. The slit members 47 may be, for example, knife edge members. The first and second emitters 2, 3 are arranged close together at a distance d from the slit 46 entrance. The first and second emitters 2, 3 may be oriented substantially parallel to one another, for example perpendicular to the slit members 47 defining the slit 46. Alternatively, the first and second emitters 2, 3 may be oriented to converge on the slit 46.

Each pair of first and second emitters 2, 3 may be arranged such that the slit 46 perpendicularly bisects the pair of emitters 2, 3, when the arrangement is viewed along a direction perpendicular to the slit members 47 defining the slit 46. For example, if the slit members 47 define the slit in an x-y plane with reference to a set of Cartesian axes, then the slit 46 should perpendicularly bisect each pair of emitters 2, 3 when viewed along the z axis.

Optionally, a diffuser 48 may be arranged at a point between the slit 46 and the emitters 2, 3. One or more lenses (not shown) may also be included to collect and/or focus light 5, 6 from the light emitters 2, 3.

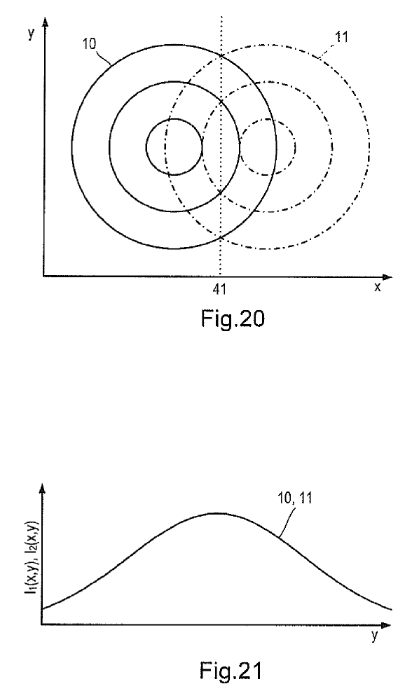

Referring also to FIGS. 20 and 21, each of the first and second emitters 2, 3 may have a substantially similar, cylindrically symmetric angular emission profile. For example, the first and second emitters 2, 3 may have Gaussian angular emission profiles. Along a line which perpendicularly bisects the central points of the circularly symmetric normalised intensity profiles 10, 11, the values of each normalised intensity profile 10, 11 will be substantially equal, i.e. I₁(x,y)=I₂(x,y) along the perpendicular bisector. In this way, the first and second normalised intensity profiles (beam profiles) 10, 11 may be substantially equal along the length of the slit 46 using a relatively simple and compact optical arrangement.

The slit 46 should be relatively narrow to provide fine spatial resolution and to ensure that the normalised intensity profiles 10, 11 are substantially equal across the width t of the slit 41. The slit may have a width between 100 μm and 1 mm inclusive. Preferably, the slit has a width between 300 μm and 500 μm inclusive.

Coupling light 5, 6 from the first and second emitters 2, 3 into the optical path 7 through a slit 46 may be used for measurements in transmission or reflection.

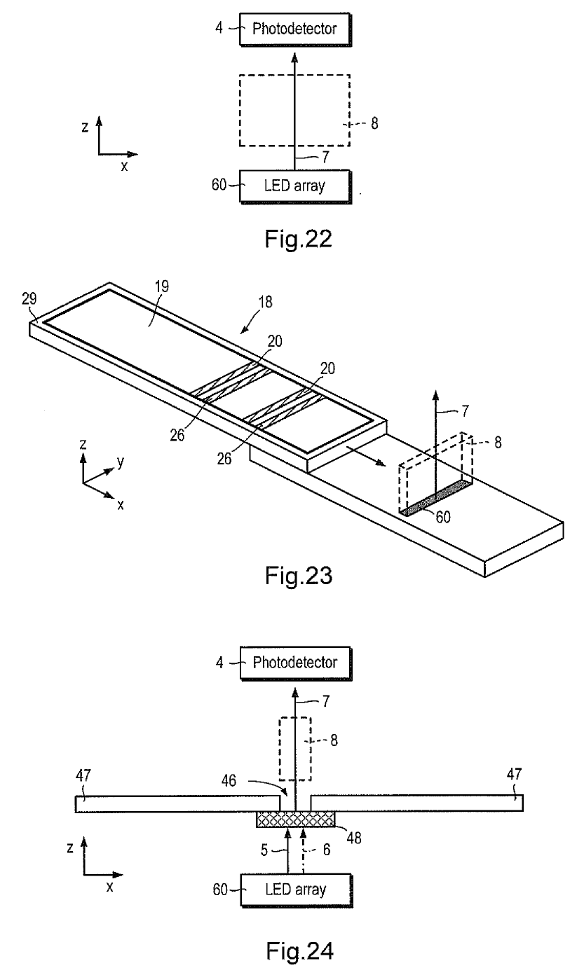

Referring also to FIG. 22, in some examples of an analytical test device 1, the optical path 7 need not include any conventional optical components. For example, a light emitting diode array 60 may simply be arranged at the other end of a plain optical path 7 to a photodetector 4, i.e. the optical path 7 only includes the sample receiving portion 8. The light emitting diode array 60 includes at least two light emitting diodes, i.e. one first light emitter 2 and one second light emitter 3. The light emitting diode array 60 may be composed of a plurality of light emitting diode pixels of similar dimensions to those found in light emitting diode display devices for computers, televisions and so forth. The light emitting diode array 60 may include a mixture of first and second emitters 2, 3.

Where samples 9 include multiple regions of interest, the sample 9 may be moved in front of the light emitting diode array 60 to scan the sample 9. Alternatively, the light emitting diode array 60 and corresponding photodetector 4 may be moved to scan the sample 9. Alternatively, a light emitting diode array 60 and one or more photodetectors 4 may be arranged corresponding to each region of interest of the sample 9 so that each region may be measured concurrently.

A light emitting diode array 60 may be used for measurements in reflection or transmission.

Referring also to FIG. 23, the light emitting diode array 60 may extend in one direction or may be a linear light emitting diode array 60.

For example, when a sample is in the form of a lateral flow test strip 18 which extends longitudinally in a first direction x, transversely in a second direction y and has a thickness in a third direction z, a light emitting diode array 60 may extend for substantially the width of the lateral flow test strip 18 in the transverse y direction and for a relatively shorter distance in the longitudinal x direction. If the lateral flow test strip 18 is mounted in a sample mounting stage 29 including a window for transmission measurements, then the light emitting diode array 60 may extend for substantially the width of the lateral flow test strip 18. Alternatively, the lateral flow test strip 18 may be mounted fixedly with respect to the analytical test device 1, and a pair of an LED array 60 and a photodetector 4 may be provided corresponding to each test region 20 and/or control region 26

Referring also to FIG. 24, although additional optical components are not required using a light emitting diode array, it may be advantageous for the light 5, 6 from first and second light emitters 2, 3 forming the light emitting diode array 60 to be passed through a slit 46 defined by slit members 47 before entering the optical path 7. In this way, the spatial resolution of measurements made using a light emitting diode array 60 may be improved.

Optionally, a diffuser 48 may be arranged between the light emitting diode array 60 and the sample receiving portion 8 of the optical path 7. One or more lenses (not shown) may also be included to collect and/or focus light 5, 6 from the light emitting diode array 60.

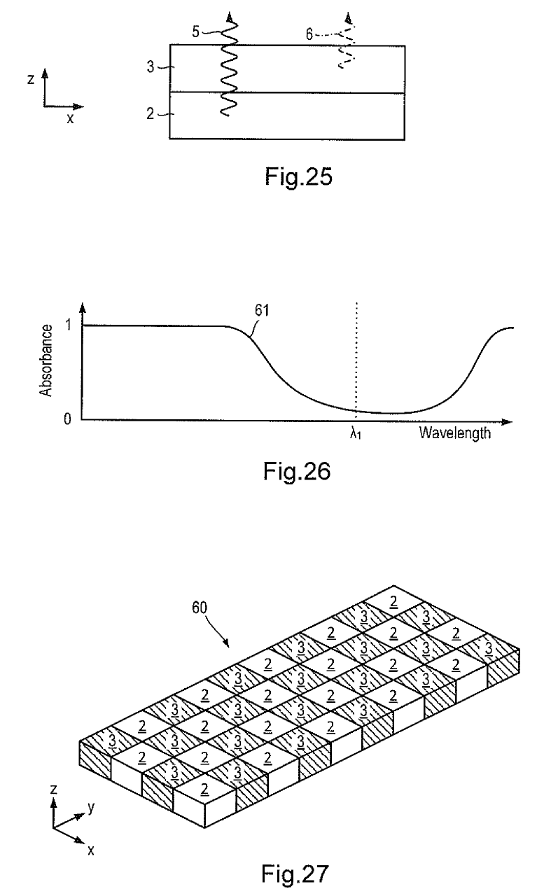

Referring also to FIGS. 25 and 26, one way to implement a light emitting diode array 60 is to stack the first and second emitters 2, 3 on top of each other. Each first light emitter 2 takes the form of a light emitting diode with a peak emission at the first wavelength λ₁ and the corresponding second light emitter 3 takes the form of a light emitting diode with a peak emission at the second wavelength λ₂. The first and second light emitters 2, 3 may be separately addressed to allow for alternating illumination.

The second light emitter 3 may be manufactured using materials which are transparent, or substantially transparent at the first wavelength λ₁. For example, the absorbance 61 of the second light emitter 3 at the first wavelength λ₁ may be relatively low. Absorbance may be considered to be relatively low if it is less than 50%, less than 25%, less than 15%, less than 10% or less than 5% (i.e. transmittance of more than 50%, more than 75%, more than 85%, more than 90% or more than 95%). In this way, the light emitting diode providing the second light emitter 3 may be deposited on top of the light emitting diode providing the first light emitter 2, and the first emitter 2 may emit light 5 onto the optical path 7 through the second light emitter 2.

This arrangement may be particularly compact for transmission measurements, but may also be used for reflectance measurements.

Referring also to FIG. 27, another option for a light emitting diode array 60 is to arrange a plurality of first and second light emitters 2, 3 into an array in which the first and second light emitters 2, 3 alternate in a “chess-board” pattern. When the individual light emitters 2, 3, or pixels, of the light emitting diode array 60 are made small, for example comparable with pixels of a light emitting diode display or television, the normalised spatial intensity profiles 10, 11 generated by the first and second light emitters 2, 3 may be substantially uniform and equal to one another at distances more than a few times the typical pixel dimensions. For example, the pixel pitch of the light emitting diode array 60 may be within the range from 5 μm to 300 μm inclusive. The differences between the normalised spatial intensity profiles 10, 11 may be further reduced by arranging a diffuser 48 between the “chess-board” light emitting diode array 60 and the sample receiving portion 8 of the optical path 7. The first and second light emitters 2, 3 are separately addressable to allow for alternating illumination.

This arrangement may be particularly compact for transmission measurements, but may also be used for reflectance measurements.

Referring also to FIG. 28, the analytical test device 1 may be integrated into a self-contained, single use lateral flow testing device 62.

The lateral flow testing device 62 includes a porous strip 19 divided into a sample receiving portion 63, a conjugate portion 64, a test portion 65 and a wick portion 66. The porous strip 19 is received into a base 67. A lid 68 is attached to the base 67 to secure the porous strip 19 and cover parts of the porous strip 19 which do not require exposure. The lid 68 includes a sample receiving window 69 which exposes part of the sample receiving portion 63 to define the liquid sample receiving region 42. The lid and base 67, 68 are made from a polymer such as, for example, polycarbonate, polystyrene, polypropylene or similar materials.

The base 57 includes a recess 70 into which a pair of light emitting diode arrays 60 are received. Each light emitting diode array 60 may be configured as described hereinbefore. The lid 68 includes a recess 71 into which a pair of photodetectors 4 are received. The photodetectors 4 may take the form of photodiodes. One pair of a light emitting diode array 60 and a photodiode 4 are arranged on opposite sides of a testing region 20 of the porous strip 19. The second pair of a light emitting diode array 60 and a photodiode are arranged on opposite sides of a control region 26 of the porous strip 19. Slit members 47 separate the light emitting diode arrays 60 from the porous strip 19 to define narrow slits 46 with widths in the range between 300 μm to 500 μm inclusive. The slit members 47 define slits 46 which extend transversely across the width of the porous strip 19. For example, if the porous strip 19 extends in a first direction x and has a thickness in a third direction z, then the slits 46 extend in a second direction y. Further slit members 47 define slits 46 which separate the photodiodes 4 from the porous strip 19. The slits 46 may be covered by a thin layer of transparent material to prevent moisture entering into the recesses 70, 71. Material may be considered to be transparent to a particular wavelength λ if it transmits more than 75%, more than 85%, more than 90% or more than 95% of the light at that wavelength λ. A diffuser 48 may optionally be included between each light emitting diode array 60 and the corresponding slit 46.

A liquid sample 72 is introduced to the sample receiving portion 63 through the sample receiving window 69 using, for example, a dropper 73 or similar implement. The liquid sample 72 is transported along the liquid transport path 41 towards the second end 44 by a capillary, or wicking, action of the porosity of the porous strip 63, 64, 65, 66. The sample receiving portion 63 of the porous strip 18 is typically made from fibrous cellulose filter material.

The conjugate portion 64 has been pre-treated with at least one particulate labelled binding reagent for binding an analyte which is being tested for, to form a labelled-particle-analyte complex (not shown). A particulate labelled binding reagent is typically, for example, a nanometre- or micrometre-sized label particle 21 which has been sensitised to specifically bind to the analyte. The particles provide a detectable response, which is usually a visible optical response such as a particular colour, but may take other forms. For example, particles may be used which are visible in infrared, which fluoresce under ultraviolet light, or which are magnetic. Typically, the conjugate portion 64 will be treated with one type of particulate labelled binding reagent to test for the presence of one type of analyte in the liquid sample 72. However, lateral flow devices 62 may be produced which test for two or more analytes using two or more particulate labelled binding reagents concurrently. The conjugate portion 64 is typically made from fibrous glass, cellulose or surface modified polyester materials.

As the flow front 45 moves into the test portion 65, labelled-particle-analyte complexes and unbound label particles are carried along towards the second end 44. The test portion 65 includes one or more testing regions 20 and control regions 26 which are monitored by a corresponding light emitting diode array 60 and photodiode 4 pair. A testing region 20 is pre-treated with an immobilised binding reagent which specifically binds the label particle-target complex and which does not bind the unreacted label particles. As the labelled-particle-analyte complexes are bound in the testing region 20, the concentration of the label particles 21 in the testing region 20 increases. The concentration increase may be monitored by measuring the absorbance of the testing region 20 using the corresponding light emitting diode array 60 and photodiode 4. The absorbance of the testing region 20 may be measured once a set duration has expired since the liquid sample 72 was added. Alternatively, the absorbance of the testing region 20 may be measured continuously or at regular intervals as the lateral flow strip is developed.

To provide distinction between a negative test and a test which has simply not functioned correctly, a control region 26 is often provided between the testing region 20 and the second end 44. The control region 26 is pre-treated with a second immobilised binding reagent which specifically binds unbound label particles and which does not bind the labelled-particle-analyte complexes. In this way, if the lateral flow testing device 62 has functioned correctly and the liquid sample 72 has passed through the conjugate portion 64 and test portion 65, the control region 26 will exhibit an increase in absorbance. The absorbance of the control region 26 may be measured by the second pair of a light emitting diode array 60 and a photodiode 4 in the same way as for the testing region 20. The test portion 65 is typically made from fibrous nitrocellulose, polyvinylidene fluoride, polyethersulfone (PES) or charge modified nylon materials. All of these materials are fibrous, and as such the sensitivity of the absorbance measurements may be improved by subtracting the measurements obtained using the second wavelength λ₂ to correct for inhomogeneity of the porous strip 19 material.

The wick portion 66 provided proximate to the second end 44 soaks up liquid sample 72 which has passed through the test portion 65 and helps to maintain through-flow of the liquid sample 72. The wick portion 66 is typically made from fibrous cellulose filter material.

Although not shown in FIG. 28, the self-contained lateral flow testing device 62 also includes the controller 27, which is mounted in the base 67 or the lid 68. The lateral flow testing device 62 may also include one or more output devices 28 integrated into the base 67 or lid 68 such that a user may see the output device(s) 28 in use.

### Illustrative Experimental Data

The preceding discussion may be better understood with reference to illustrative experimental data. The analytical testing device 1 described herein is not limited to the specific conditions and samples used to obtain illustrative experimental data.

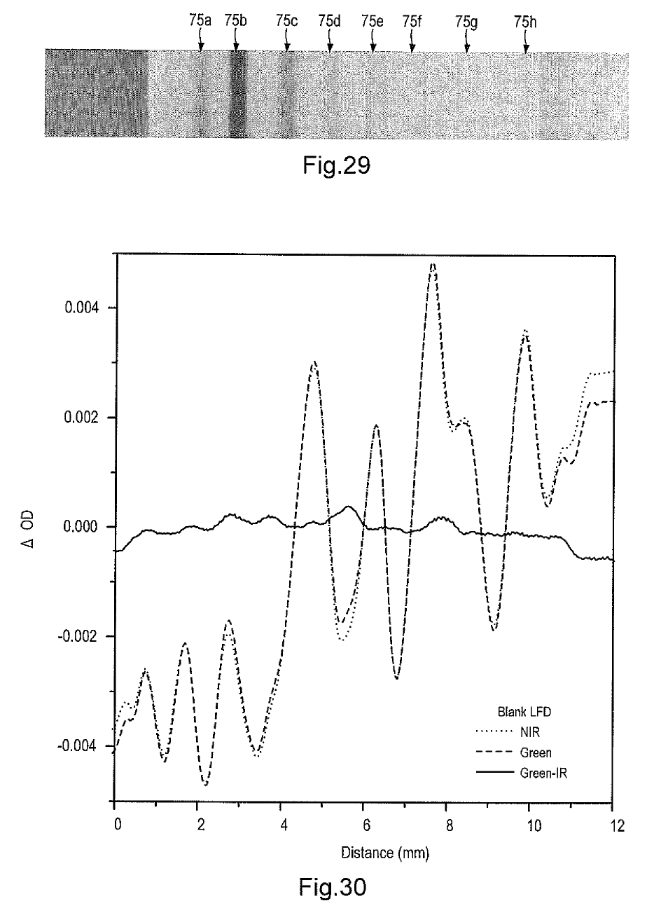

Referring to FIGS. 1, 5 and 29, test samples were prepared by depositing test lines 75 of gold nanoparticle ink onto blank porous strips 19 made from nitrocellulose. Gold nanoparticles are one type of labelling particle 21 used in lateral flow test strips 18. Each test line 75 was deposited using gold nanoparticle ink of a different solution optical density. The solution optical density of the gold nanoparticle ink, OD, may be considered to be a measure of the density of gold nanoparticles in the corresponding test line 75. For example, the test sample shown in FIG. 29 included eight test lines 75a, . . . , 75h deposited using gold nanoparticle inks having solution ODs of 15, 100, 25, 7, 5, 2, 0.8 and 0.1 respectively. Each test line 75a, . . . , 75h is 1.0±0.5 mm wide and the centre-to-centre spacing of test lines 75a, . . . , 75h is 2.0±0.5 mm.

Referring also to FIG. 3o, absorbance measurements were conducted for a blank nitrocellulose porous strip 19 and the variations of optical density ΔOD are shown as a function of position x along the blank porous strip 19. In this example, substantially equal beam profiles 10, 11 were provided using an integrating sphere (not shown) and first and second emitters 2, 3 in the form of light emitting diodes were coupled to a first port of the integrating sphere, and the light from a second port of the integrating sphere illuminated the blank strip. The photodetector 4 was disposed on the other side of the blank porous strip 19 and optical densities (absorbance) were measured in transmission. The first light emitting diode 2 emitted green light 5 (dashed line) and the second light emitting diode 3 emitted light 6 at near infra-red (NIR) wavelengths (dotted line). The beam profiles 10, 11 were substantially uniform and substantially equal due to multiple reflections inside the integrating sphere (not shown).

The measurements were obtained by moving the blank nitrocellulose porous strip 19 through a gap between the photodiode 4 and the light emitting diodes 2, 3 and recording the output signal of the photodiode 4 as a function of the distance. The blank nitrocellulose porous strip 19 was moved using a stepper motor.

It may be observed that the inhomogeneities in the transmittance of the blank nitrocellulose strip 19 are reproducible over a wide wavelength range, since the measurements at the green and near-infrared wavelengths are substantially similar. Subtracting measurements made at a second wavelength may substantially correct for the background inhomogeneity of the porous strip 19. For example, for absorbance measurements A₁(x) obtained with the green light emitting diode alone, the range of ΔOD was more than 00008, whereas the difference A₁(x)-A₂(x) (solid line) has a range of ΔOD of ≈0.001. This represents a substantial decrease in the background signal, and consequently lower optical densities of labelling particles 21 may be resolvable.

The gold nanoparticles used for the test lines 75, which are commonly used as labelling particles 21 in lateral flow test strips 18, are known to absorb strongly in the green but only relatively weakly in the infrared. Therefore, one example of an analytical test device as described herein may compare the difference in signals obtained using green and near-infrared organic light emitting diodes. The same approach may also be used with an imaging camera approach.

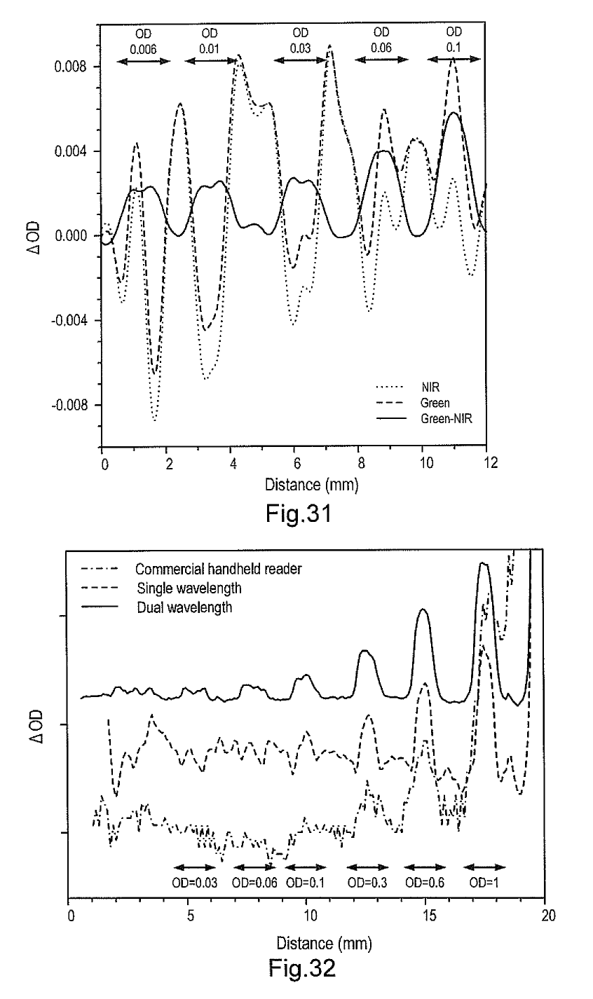

Referring also to FIG. 31, a test sample including test lines 75 was measured using green light (dashed line) and NIR light (dotted line). The test sample used included test lines 75 deposited using inks having solution optical densities of 0.006, 0.01, 0.03, 0.06 and 0.1. The corrected signal (solid line) obtained by subtracting the NIR signal from the green signal displays reduced background variability, which allows the signals resulting from the test lines 75 to be resolved. It is observed that the test lines 75 deposited using inks having solution optical densities of 0.006, 0.01, 0.03, 0.06 and 0.1 would be effectively unresolvable using green light alone, yet can be readily distinguished using the corrected signal.

Referring also to FIG. 32, a comparison is shown between a measurements using the difference between absorbance ΔOD at green and NIR wavelengths (solid line), absorbance ΔOD measured using only the green light (dashed line) and absorbance ΔOD measured using a commercially available handheld lateral flow device reader (chained line). The commercial handheld reader was an Optricon (TRM) Cube-Reader (RTM). The different measurement series have been shifted in the y-axis direction to improve readability of the figure. It may be observed that the corrected, dual-wavelength measurement allows resolution of the fainter lines corresponding to inks having solution optical densities of OD=0.1 and lower.

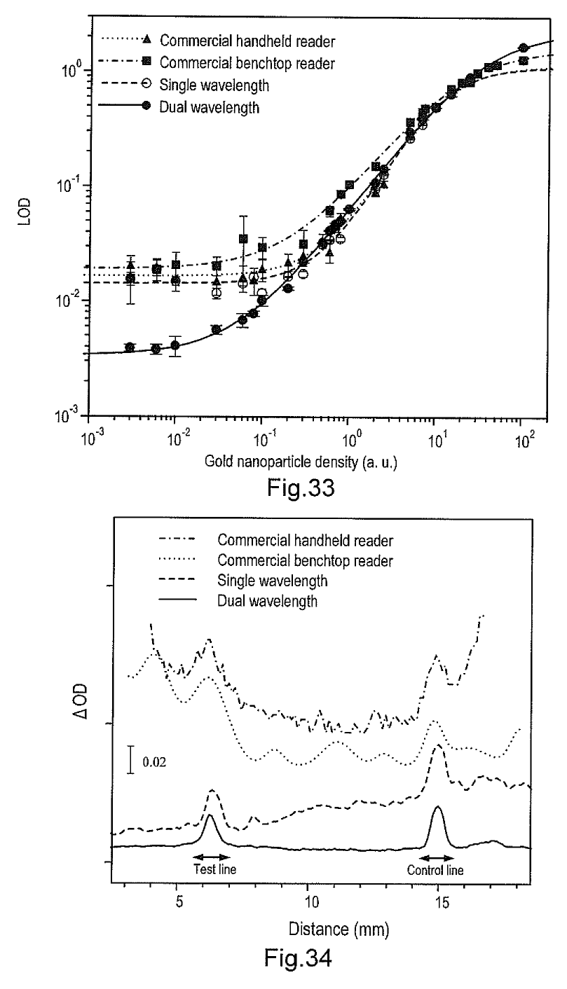

Referring also to FIG. 33, the limiting optical density (LOD), i.e. the smallest resolvable change in absorbance as a function of gold nanoparticle density was determined using test line 75 for the difference between absorbance ΔOD at green and NIR wavelengths (solid line), absorbance ΔOD measured using only the green light (dashed line), absorbance ΔOD measured using a commercially available benchtop lateral flow device reader (chained line) and the absorbance ΔOD measured using the handheld lateral flow device reader (chained line). The commercial benchtop reader was a Qiagen (RTM) ESEQuant (RTM) lateral flow reader. The LOD of ˜0.01 to 0.02 (DOD) observed with commercial readers or single wavelength absorbance measurements is limited by inhomogeneity of the nitrocellulose porous strip 19, which masks test lines 75 printed on the porous strip 19. For the dual wavelength (solid line) measurements, the effect of nitrocellulose thickness variation can be reduced down to LOD ˜1.4×10⁻³ with the use of two LEDs, or to a LOD of ˜5×10⁻⁴ using an integrating sphere to illuminate the test lines 75.

Referring also to FIG. 34, experimental data obtained by scanning a lateral flow test strip 18 for performing a Troponin assay are shown for the commercially available handheld reader (chained line), the commercially available benchtop reader (dotted line), a simple transmission reader (dashed line) using a green light emitting diode arranged opposite to an photo diode, and an example of the analytical test device 1 (solid line). The analytical test device 1 used in this case operated in transmission mode, the first emitter 2 was a green light emitting diode and the second emitter 3 was a near-infrared light emitting diode. The different measurement series have been shifted in the y-axis direction to improve readability of the figure.

It may be observed that measurements obtained using the example analytical test device 1 have substantially reduced background noise compared to a single wavelength organic light emitting diode/organic photodiode pair. Although the test region 20 and control region 26 are well resolved in this illustrative data, the reduced background noise may allow the analytical test device 1 to detect lower concentrations than the single wavelength (green only) device.

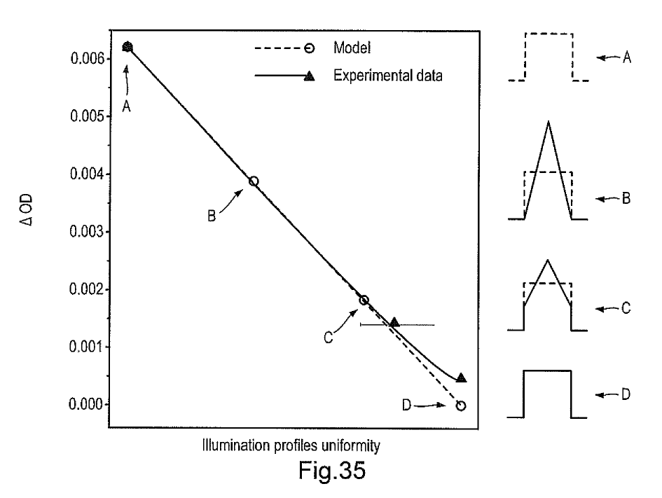

Referring also to FIG. 35, measurements and modelling results on the absorbance variation ΔOD of a blank nitrocellulose porous strip 19 are shown. The y-axis (ΔOD) is optical density variation along the porous strip 19, i.e. the maximum-minimum of ΔOD for the porous strip 19. The increasing x-axis direction corresponds to increasing similarity of the first and second beam profiles 10, 11.

Data corresponding to three experimental measurements are shown (triangles, solid line is a fitting line). The leftmost, or least equal point corresponds to ΔOD measured with no correction using the second emitter, i.e. the NIR wavelengths. The rightmost, or most equal point corresponds to ΔOD measured using an integrating sphere (not shown). The third (middle) experimental point corresponds to ΔOD measured using a simple (side-by-side) pair of inorganic LEDs emitting green and NIR light respectively. The values of ΔOD measured using a pair of light emitting diodes is three times higher than ΔOD measured using the integrating sphere (not shown), which may be attributable to a degree of difference between the first and second beam profiles 10, 11. However, the measurements using the pair of light emitting diodes are also ˜4.5 times lower than ΔOD measured with only the green wavelengths.

Data corresponding to the results of modelling of the ΔOD achievable for different beam profiles of first (green) and second (NIR) emitters 2, 3 are also shown (open circles, dashed line is a fitting line). Modelling was performed by convolving experimentally measured ΔOD data corresponding to a blank porous strip 19 with different beam profiles A, B, C and D shown schematically in FIG. 35. A first set of beam profiles A corresponds to single wavelength measurement (i.e. NIR illumination profile is absent), and represents a minimum uniformity (or maximum difference). A set of beam profiles D corresponds to identical first and second beam profiles 10, 11, and represents maximum uniformity. The beam profiles B and C represent intermediate situations in which the first and second beam profiles 10, 11 exhibit differences.

The measured data corresponding to the integrating sphere (not shown) is larger than the modelled value of zero. This may be attributable to the beam profiles not being perfectly identical, or may possibly be attributable to deviations from the simple nitrocellulose thickness variation model which is employed for correction by subtracting the absorbance values measured using the second colour. The value of ΔOD ˜5e-4 for the integrating sphere (not shown) measurements is nonetheless substantially reduced in comparison to the single wavelength value ΔOD >0.06.

### Modifications

It will be appreciated that many modifications may be made to the embodiments hereinbefore described. Such modifications may involve equivalent and other features which are already known in the design, manufacture and use of analytical test devices and which may be used instead of or in addition to features already described herein. Features of one embodiment may be replaced or supplemented by features of another embodiment.

Although applications have been predominantly described in relation to absorbance measurements with LFDs, fluorescence measurements may also be made using the same methods described hereinbefore and a measurement process which is similar to the hereinbefore described process of obtaining and correcting absorbance measurements (see FIG. 11).

For example, as described hereinbefore, the first light emitter(s) 2 may be switched off for a period of duration δt₀, so that the photodetector(s) 4 may measure fluorescence excited by the light 5 from the first light emitter(s) 2 (step S3). In a similar way, the so second light emitter(s) 3 may be switched off for a period of δt₀, so that the photodetector(s) 4 may measure fluorescence excited by the light 6 from the second light emitter(s) 2 (step S5). This approach can be used to excite a first fluorescent marker using light 5 of the first wavelength λ₁ and to excite a second fluorescent marker using light 6 of the second wavelength λ₂.

A fraction of light 5 at the first wavelength A, will be scattered by the fibres 22, and thus not available to excite fluorescence. Similarly, a fraction of light 6 at the second wavelength λ₂ will be scattered by the fibres 22, and thus not available to excite fluorescence. However, as described hereinbefore, the fibres 22 scatter light at the first and second wavelengths λ₁, λ₂ in approximately the same way. Thus, the impact of the inhomogeneity of the porous strip 19 on fluorescence measurements excited at the first and second wavelengths λ₁, λ₂ can be substantially the same. This can improve the accuracy of assays which are based on the relative concentrations of two (or more) fluorescent markers.

Alternatively, the first emitter 2 may be used to measure fluorescence excited by the first wavelength λ₁ and the second emitter 3 may be used to perform a correction.

Referring again to FIG. 13, the first emitter 2 may be illuminated for a duration δt₁, followed by first and second emitters 2, 3 both being unilluminated for a duration δt₀, followed by illumination of the second emitter 3 for a duration δt₂. During the illumination period δt₁ of the first emitter 2, fluorescent markers are excited, and the fluorescence is detected during the unilluminated period δt₀. During the illumination period δt₂ of the second emitter 3, the absorbance of light 6 at the second wavelength λ₂ (in reflectance or transmittance) is determined using as a reference level (i.e. absorbance of zero) the optical path 7 when there is no sample 9. As explained hereinbefore, the absorbance of the porous strip 19 which is attributable to scattering by the fibres 22 is expected to co-vary between the first and second wavelengths λ₁, λ₂. In this way, the quantity of light 5 of the first wavelength λ₁ which is available to excite fluorescence may be expected to vary in proportion to (1−A₂(x)), in which A₂(x) represents the absorbance determined at the second wavelength λ₂. The measured fluorescence excited by the light 5 at the first wavelength λ₁ may be corrected to reduce or remove the influence of inhomogeneity of the porous strip 19 by dividing the measured fluorescence values by (1−A₂(x)). This may improve the limit of detection of lateral flow fluorescence assays.

Although examples have been described in relation to lateral flow test strips 18, the present methods and apparatus can also be used with other types of sample 9 with minimal modifications.

For example, an analytical test device r may include an optical path 7 which has a sample receiving portion 8 adapted to receive a microfluidic channel or channels (not shown) perpendicularly to the optical path 7. The microfluidic channel(s) (not shown) can be in the form of one or more lengths of tubing or one or more channels machined into polymeric material. The microfluidic channel(s) (not shown) may be dimensioned to enable capillary transport of a liquid sample. Measurements at the second wavelength λ₂ can be used to compensate for scattering or absorption from defects of or contamination on the walls of the microfluidic channel(s) (not shown).

Expansion to More than One Analyte

For some tests, it may be desirable to detect and quantify the concentrations of two or more analytes in the same sample concurrently. Additionally or alternatively, many samples which may contain one or more analytes of interest may be coloured, for example blood. Other samples may display a range of colours depending on a concentration of, for example, urine or other biologically derived substances or byproducts.

The methods and apparatus described hereinbefore can be adapted to detect two or more analytes in a single sample, whether the sample is coloured or substantially clear.

In general, concentrations of N−1 different analytes may be determined whilst correcting for inhomogeneity of a porous strip 19, or other such source of background scattering, by sequentially illuminating the sample receiving portion 8 using N different wavelengths. Each of the N wavelengths may be provided by a corresponding set of one or more light emitters. The controller 27 may illuminate each of the N sets of one or more light emitters according to a sequence, such that only one set of emitters is emitting light at any given time. Some of the N−1 analytes may not be of direct interest, for example, some of the N−1 analytes may be substances or compositions which provide the colouration of a sample. However, accounting for analytes providing coloration of a sample can allow more accurate detection and quantification of analytes of interest contained in the sample.

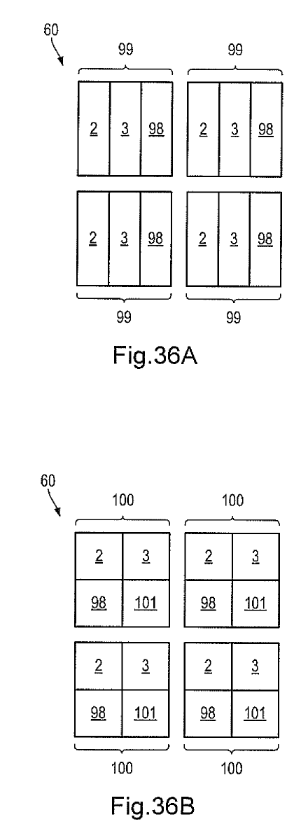

Referring also to FIGS. 36A and 36B, the second or third arrangements (FIGS. 25, 27) for coupling light into an optical path 7, using an LED array 60, may be readily adapted for more than two sets of light emitters.

Referring in particular to FIG. 36A, an LED array 60 may include a number of pixels 99, each of which includes a first emitter 2, a second emitter 3 and a third emitter 98 in the form of LED sub-pixels.

Referring in particular to FIG. 36B, an LED array 60 may include a number of pixels 100, each of which includes a first emitter 2, a second emitter 3, a third emitter 98 and a fourth emitter 101 in the form of LED sub-pixels.

The transmission geometry shown in FIG. 14 or the reflection geometry shown in FIG. 15 may be used for sequential illumination by light emitted by more than two sets of emitters. A photodetector 4 in the form of an image sensor 24 (FIG. 16) may be used to image the sample receiving portion 8 of the optical path 7.

### Method of Extracting Analyte Concentrations

A sample may in general include N−1 analytes. The method of extracting concentrations for the N−1 analytes includes sequentially illumination using light emitted from N sets of one or more light emitters. Each set of light emitters emits light centred around a different wavelength. The number N−1 of analytes is one less than the number N of sets of emitters to allow correction for scattering from the background inhomogeneities of a porous strip 19, microfluidic channel(s), or any similar source of background scattering. Some of the analytes may be substances or compositions which give rise to the coloration of a sample. Quantifying substances or compositions which give rise to sample colouration may not be of direct interest, however, it can allow more sensitive detection and/or more accurate quantification of one or more analytes of interest contained within a coloured sample such as urine, blood, wine, cooking oils and so forth.

For light of the n^{th} wavelength λₙ out of N−1 wavelengths, the absorbance through the sample receiving portion 8 is denoted A(λₙ). In general, the absorbance A(λₙ) corresponds to a range of wavelengths which spans the n^{th} wavelength λₙ. For example, A(λₙ) may be calculated based on the integral of intensity across a wavelength range.

The total absorbance A(λₙ) may be viewed as the sum:

$$A ( {λ}_{n} ) = s ( {λ}_{n} ) + {{\sum }_{i = 1}}^{N - 1} {ɛ}_{i} ( {λ}_{n} ) {c}_{i} \qquad ( 5 )$$

in which s(λₙ) is the absorbance at the n^{th} wavelength λₙ due to scattering from background inhomogeneity of the porous strip 19 or other source of background scattering, cᵢ is the concentration of the i^{th} analyte out of N−1 analytes and εᵢ(λₙ) is a coefficient relating the concentration cᵢ to the absorbance of the i^{th} analyte out of N−1 analytes at the n^{th} wavelength λₙ. The concentrations cᵢ are expressed in units of absorbance (optical density) corresponding to a reference wavelength, for example, the 1^{st} wavelength λ₁. Thus, the coefficients εᵢ(λₙ) are each a ratio of the absorbance of the i^{th} analyte between the 1^{st} and n^{th} wavelengths λ₁, λₙ.

Measurement of absorbance may be direct, for example, in a transmission geometry by obtaining measurements with and without a sample 9 present within the sample receiving portion 8.

Alternatively, when the sample 9 is a lateral flow test strip 18, the absorbance values A(λₙ) may be obtained from an image or scan covering a testing region 20 and surrounding regions of untreated porous strip 19. Alternatively, the absorbance values A(λₙ) may be obtained by reference to a measurement of transmission/reflection obtained before a liquid sample is introduced to the lateral flow test strip.

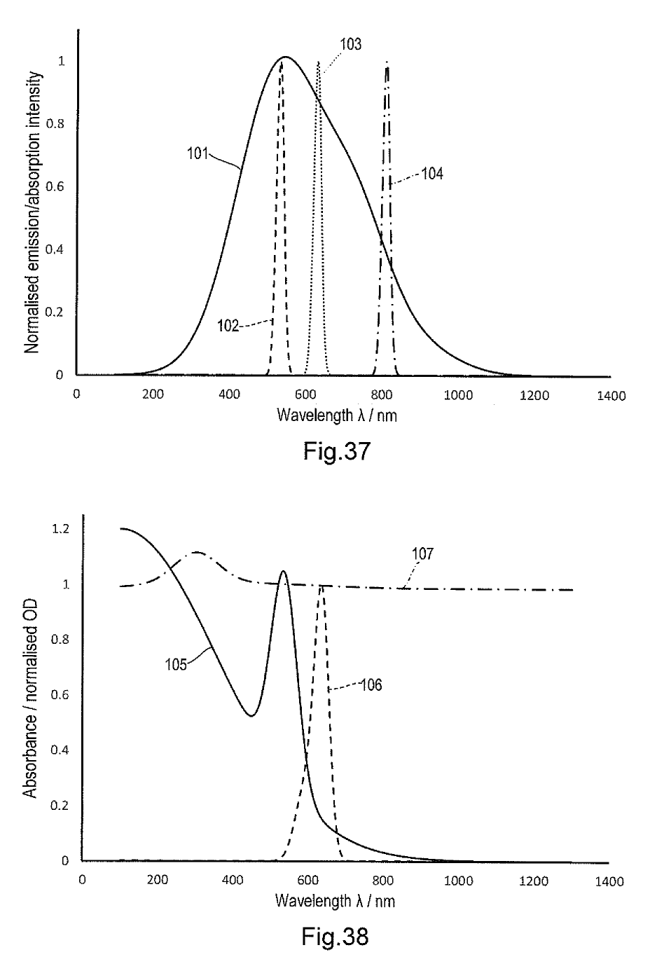

Referring also to FIGS. 37 to 48 a method of obtaining absorbance values A(λₙ), also referred to as absorbance “fingerprints” from a lateral flow strip 20 is explained with reference to theoretically modelled organic photodetector (OPD) signals.

Referring in particular to FIG. 37, the model for generating theoretical OPD signals is based on a representative OPD absorption profile 101, which is a function of wavelength λ, in combination with representative LED emission profiles 102, 103, 104, which are each functions of wavelength λ. The first LED emission profile 102 corresponds to a typical green OLED, the second LED emission profile 103 corresponds to a typical red OLED, and the third LED emission profile 104 corresponds to a typical near infrared (NIR) OLED.

Referring in particular to FIG. 38, further inputs to the model for generating theoretical OPD signals include representative absorption profiles 105, 106, 107 for gold nanoparticles, a blue dye and nitrocellulose fibres 22 respectively. The first absorption profile 105 is a wavelength λ dependent function corresponding to the absorbance of gold nanoparticles. The second absorption profile 106 is a wavelength λ dependent function corresponding to the absorbance the blue dye. The third absorption profile 107 is a wavelength λ dependent function corresponding to the absorbance of nitrocellulose fibres 22 forming a porous strip 19.

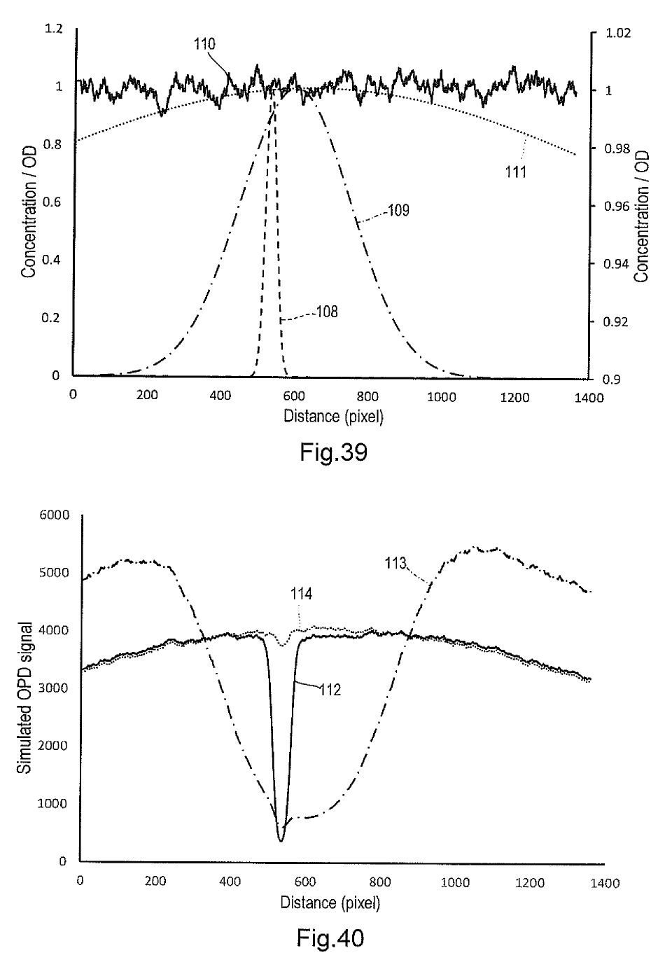

Referring in particular to FIG. 39, further inputs to the model for generating theoretical OPD signals include assumed concentration profiles 108, 109, 110 of gold nanoparticles, blue dye and nitrocellulose fibres respectively. In the model, it is assumed that the lateral flow test strip 18 is back-illuminated and that the light transmitted through the lateral flow test strip 18 is imaged using a number of OPDs forming an image sensor 24. The x-axis of FIG. 39 is distance in units of pixels of the image sensor 24. Equivalent information could be modelled or measured by scanning a single OPD along the length of the lateral flow test strip 18 (in which case the distance units would be, for example, mm rather than pixels). The first assumed concentration profile 108, plotted against the primary Y-axis (range 0 to 1.2), corresponds to a position dependent concentration of gold nanoparticles. The second assumed concentration profile 109, plotted against the primary Y-axis (range 0 to 1.2), corresponds to a position dependent concentration of blue dye. The third assumed concentration profile no, plotted against the secondary Y-axis (range 0.9 to 1.02), corresponds to a position dependent concentration of nitrocellulose fibres 22. The third assumed concentration profile no includes fluctuations of the nitrocellulose fibre 22 concentration (meaning the density such, for example, fibre volume fraction) with position along the porous strip 19. Also indicated in FIG. 39 is an illumination profile in representing a varying illumination intensity at different positions along the length of a lateral flow test strip 18. The illumination profile 111 is assumed to be the same for modelled green, red and NIR OLEDS.

Referring in particular to FIG. 40, simulated OPD signals 112, 113, 114 corresponding to green, red and NIR OLEDs respectively may be estimated based on the emission profiles 102, 103, 104, illumination profile in, concentration profiles 108, 109, 110 and absorbance profiles 105, 106, 107. Noise generated based on pseudo-random numbers was added to simulated OPD signals 112, 113, 114 to simulate OPD noise.

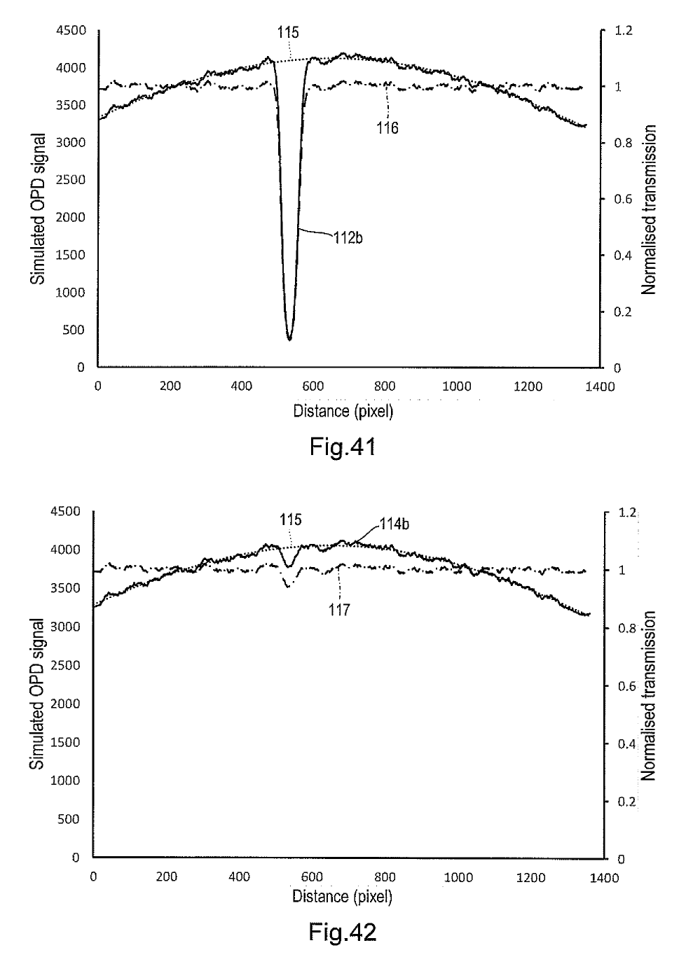

Referring in particular to FIG. 41, a simulated green OPD signal 112b is shown which is calculated for a case in which the blue dye concentration profile 109 is zero everywhere.

As a first step in extracting green absorbance values, a slowly varying background profile 115, plotted against the primary Y-axis (range 0 to 4500), is fitted to the simulated green OPD signal 112b, plotted against the primary Y-axis (range 0 to 4500). The background profile 115 represents an approximation to the average intensity, T₀, transmitted by the nitrocellulose fibres 22 of the porous strip 19. The simulated green OPD signal 112b represents the transmitted intensity, T, through the porous strip 19 and the gold nanoparticles. A normalised green transmission profile 116 is calculated as T/T₀, plotted against the secondary Y-axis (range 0 to 1.2). It may be observed that the normalised green transmission profile 116 retains fluctuations resulting from the point-to-point fluctuations in the nitrocellulose fibre 22 concentration profile 110.

Referring in particular to FIG. 42, a simulated NIR OPD signal 114b is shown which is calculated for a case in which the blue dye concentration profile 109 is zero everywhere. As a first step in extracting IR absorbance values, a slowly varying background profile 115, plotted against the primary Y-axis (range 0 to 4500) is fitted to the simulated NIR OPD signal 114b, plotted against the primary Y-axis (range 0 to 4500). Given the present modelling assumptions, the background profile 115 is the same for green and NIR data, however, in practice the background profile 115 may vary for different light emitters 2, 3, 98. A normalised NIR transmission profile 117 is calculated as T/T₀, plotted against the secondary Y-axis (range 0 to 1.2).

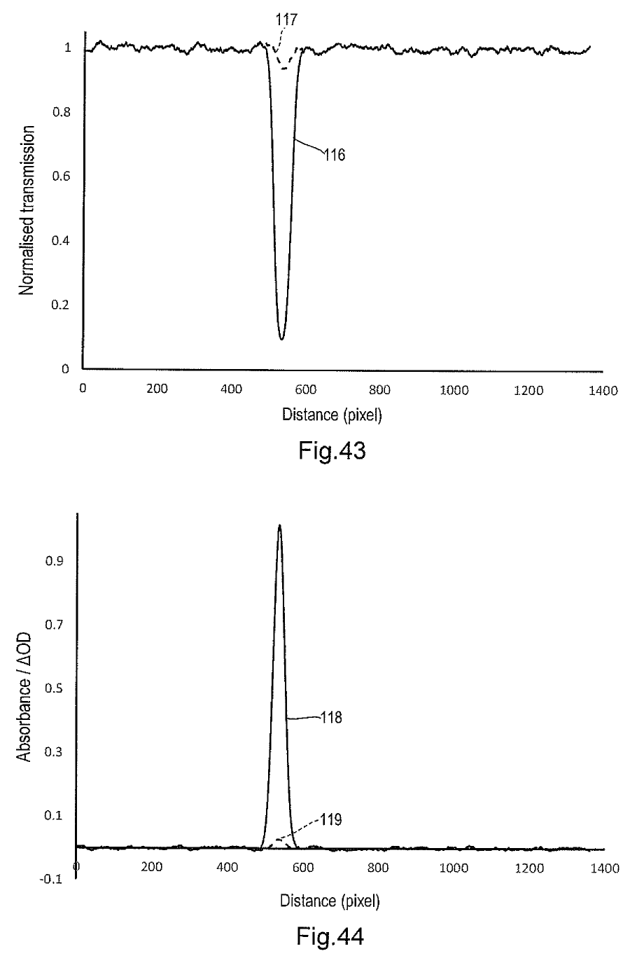

Referring in particular to FIGS. 43 and 44, the normalised transmission profiles 116, 117 are converted to absorbance values according to the formula A=−log₁₀(T/T₀). A first simulated absorbance profile 118 is obtained corresponding to the green OLED and comprising green absorbance values A_{G}(x) at pixel position x. A second simulated absorbance profile 119 comprising NIR absorbance values A_{NIR}(x) is obtained corresponding to the NIR OLED. The absorbance values calculated in this fashion are more strictly viewed as changes in absorbance relative to a perfectly uniform nitrocellulose strip having the same concentration (density/fibre volume fraction) as the average concentration (density/fibre volume fraction) of the porous strip 19. Such values may also be referred to as delta-optical density or ΔOD values. Although the calculation has been outlined with reference to a transmission geometry, analogous calculations may be performed for a reflection geometry.

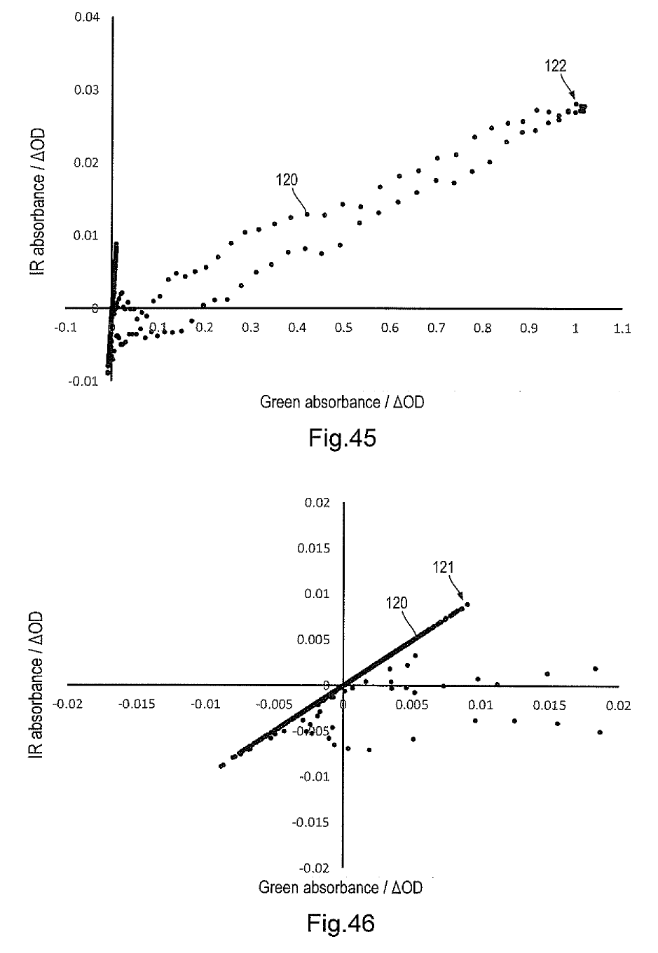

Referring in particular to FIGS. 45 and 46, the estimated of absorbance fingerprint values is illustrated. Both of FIGS. 45 and 46 are scatter plots of the green simulated absorbance profile 118 plotted against the X-axis and the NIR simulated absorbance profile 119 against the Y-axis. Each data point 120 represents a pair of a green absorbance value A_{c}(x) and a NIR absorbance value A_{NIR}(x) at a particular position x of a simulated lateral flow device 18.

Two distinct correlations may be observed in FIGS. 45 and 46 having different slopes. A first correlation is most easily seen in FIG. 46 and has approximately unitary slope. This corresponds to the nitrocellulose fibres, the interaction of which with green and NIR wavelengths is essentially the same in the model, and also in practice. By examining the extremal data points 121 of the first correlation, a pair of absorbance values attributable to the fluctuations in the nitrocellulose fibre 22 concentration profile 110, also referred to as the absorbance “fingerprint” of the nitrocellulose fibres 22, may be estimated as A_{NC}(λ_{G})≈0.01, A_{NC}(λ_{NIR})≈0.01, or alternately A_{NC}≈(0.01, 0.01) using a vector notation.

A second correlation is most easily seen in FIG. 45 and has a much shallower slope representing the relatively strong response of the green light to the gold nanoparticles in comparison to the relatively weak response of the NIR light to the gold nanoparticles. In a similar fashion to the first correlation, for the second correlation an absorbance “fingerprint” corresponding to the gold nanoparticles may be estimated as A_{NC}(λ_{G})≈1, A_{NC}(λ_{NIR})≈0.02, or A_{Au}≈(1, 0.02) using a vector notation, based on the extremal points 122 and subtracting the signal due to variations in the nitrocellulose fibre 22 concentration profile 110. This method of estimating absorbance fingerprints may be extended to three or more wavelength bands of light, for example, by using 3D plots or N-dimensional analysis methods.

The method of obtaining absorbance values described with reference to the simulated OPD signals 112, 113, 114 is expected to be equally applicable to measured data, whether obtained in transmission or reflection geometries.

Other methods of obtaining absorbance values may be used. Absorbance values measured according to any suitable method may be analysed in accordance with equations (6) to (13), (10b) to (13b) and/or equation (10c) as set out hereinafter.

In the general case, for light of the n^{th} wavelength λₙ out of N−1 wavelengths, the absorbance (however measured) through the sample receiving portion 8 is denoted A(λₙ). If the absorbance A(λₙ) is measured at each wavelength λₙ, then an absorbance column vector may be defined as:

$$A = ( \begin{matrix}A ( {λ}_{1} ) \\ A ( {λ}_{2} ) \\ ⋮ \\ A ( {λ}_{N} )\end{matrix} ) \qquad ( 6 )$$

For example, the absorbance values A(λₙ) may be absorbance fingerprint values obtained as described hereinbefore with reference to FIGS. 45 and 46.

Similarly, a concentration column vector may be defined as:

$$c = ( \begin{matrix}{c}_{1} \\ {c}_{2} \\ ⋮ \\ {c}_{N - 1} \\ {c}_{s}\end{matrix} ) \qquad ( 7 )$$

in which the concentration cₛ corresponding to the background absorbance s(λₙ) is a dummy concentration which is set to the background absorbance at the reference wavelength, for example s(λ₁) at the 1^{st} wavelength λ₁. The use of the dummy concentration in equivalent units to the analyte concentrations cᵢ maintains appropriate scaling of measured absorbance values throughout the calculations described hereinafter. In practice, as explained hereinafter, calibration of the method typically includes obtaining measurements of the background scattering without any analytes, so obtaining a suitable value for the dummy concentration cₛ is not problematic. The absorbance vector A may be expressed in terms of the coefficients εᵢ(λₙ), background absorbance s(λₙ) and concentration vector c using a matrix equation:

$$( \begin{matrix}A ( {λ}_{1} ) \\ A ( {λ}_{2} ) \\ ⋮ \\ A ( {λ}_{N - 1} ) \\ A ( {λ}_{N} )\end{matrix} ) = ( \begin{matrix}{ɛ}_{1} ( {λ}_{1} ) & {ɛ}_{2} ( {λ}_{1} ) & … & {ɛ}_{N - 1} ( {λ}_{1} ) & s ( {λ}_{1} ) \\ {ɛ}_{1} ( {λ}_{2} ) & {ɛ}_{2} ( {λ}_{2} ) & … & {ɛ}_{N - 1} ( {λ}_{2} ) & s ( {λ}_{2} ) \\ ⋮ & ⋮ & ⋱ & ⋮ & ⋮ \\ {ɛ}_{1} ( {λ}_{N - 1} ) & {ɛ}_{2} ( {λ}_{N - 1} ) & … & {ɛ}_{N - 1} ( {λ}_{N - 1} ) & s ( {λ}_{N - 1} ) \\ {ɛ}_{1} ( {λ}_{N} ) & {ɛ}_{2} ( {λ}_{N} ) & … & {ɛ}_{N - 1} ( {λ}_{N} ) & s ( {λ}_{N} )\end{matrix} ) ( \begin{matrix}{c}_{1} \\ {c}_{2} \\ ⋮ \\ {c}_{N - 1} \\ {c}_{s}\end{matrix} ) \\ A = Mc \qquad ( 8 )$$

in which M is a square matrix having coefficients Mᵢⱼ=εⱼ(λᵢ) for 1≤j≤N−1 and M_{iN}=s(λᵢ). By inverting the matrix M, unknown concentrations cᵢ of analytes may be determined from the measured absorbance values A(λₙ) at each wavelength λₙ:

c=M⁻¹A (9)

In order to apply Equation (9), it is necessary to know the coefficients Mᵢⱼ of the matrix M, so that the inverse M⁻¹ may be calculated. When evaluating Equation (9), a value calculated corresponding to the background scattering “concentration” would ideally be equal to the dummy concentration cₛ. In practical circumstances, the value calculated corresponding to the background scattering “concentration” may deviate from the dummy concentration cₛ. The size of the deviation may provide an indication of variations between different porous strips 19, microfluidic channels, and so forth. A large deviation may provide an indication of possible problems with a particular sample or with the calibration of the matrix M coefficients Mᵢⱼ.

The coefficients Mᵢⱼ of the matrix M may be determined in advance from experimental measurements using samples with known concentrations cᵢ of each analyte. A measured set of absorbance values A₁(λₙ) with a first calibration sample represented by the reference absorbance vector A₁ and the corresponding concentrations cᵢ⁻¹ by the calibration concentration vector c₁. In general, for N wavelengths λ₁, . . . , λ_{N}, a number N of calibration samples and measurements are required. A fingerprint matrix F is defined using the set of reference absorbance vectors A₁, . . . , A_{N} by setting the coefficients of each reference absorbance vector A₁, . . . , A_{N} as the coefficients for a corresponding column of the fingerprint matrix F:

$$F = ( \begin{matrix}↑ & ↑ & & ↑ \\ {A}_{1} & {A}_{2} & … & {A}_{N} \\ ↓ & ↓ & & ↓\end{matrix} ) \\ F = ( \begin{matrix}{A}_{1} ( {λ}_{1} ) & {A}_{2} ( {λ}_{1} ) & … & {A}_{N} ( {λ}_{1} ) \\ {A}_{1} ( {λ}_{2} ) & {A}_{2} ( {λ}_{2} ) & … & {A}_{N} ( {λ}_{2} ) \\ ⋮ & ⋮ & ⋱ & ⋮ \\ {A}_{1} ( {λ}_{N} ) & {A}_{2} ( {λ}_{N} ) & … & {A}_{N} ( {λ}_{N} )\end{matrix} ) \qquad ( 10 )$$

The entries of the fingerprint matrix F may constitute absorbance fingerprint values estimated as described in relation to FIGS. 45 and 46. However, the entries need not be absorbance fingerprint values, and in general the entries of the fingerprint matrix F may be absorbance values measured or obtained according to any suitable method. The corresponding calibration concentration vectors c₁, . . . , c_{N} may be set as the columns of a calibration matrix C:

$$C = ( \begin{matrix}↑ & ↑ & & ↑ \\ {c}_{1} & {c}_{2} & … & {c}_{N} \\ ↓ & ↓ & & ↓\end{matrix} ) \qquad ( 11 )$$

and the fingerprint matrix F and calibration matrix C are related according to:

F=MC (12)

The coefficients Mᵢⱼ of the matrix M can then be calculated as M=FC⁻¹, and the coefficients of the inverse matrix M⁻¹ can be calculated as M⁻¹=CF⁻¹. Thus, a set of unknown concentrations cᵢ represented by a concentration vector c may be recovered using CF⁻¹ as a deconvolution matrix (also referred to as a de-mixing matrix) for the measured absorbance values A(λₙ) represented by an absorbance vector A according to:

c=CF⁻¹A (13)

In this way, a set of unknown concentrations c₁, . . . , c_{N-1} of N−1 analytes may be reconstructed from measurements of the absorbance values A(λ₁), . . . , A(λ_{N}) at N wavelengths, λ₁, . . . , λ_{N} emitted from the corresponding N sets of light emitters. The absorbance values A(λ₁), . . . , A(λ_{N}) may be in the form of absorbance fingerprint values obtained as described in relation to FIGS. 45 and 46, or may be absorbance values obtained or estimated using any other suitable method.

The actual physical concentration or number density of each analyte, for example in units of number.cm⁻³, can be estimated from the reconstructed concentrations c₁, . . . , c_{N-1} (i.e. absorbance values at the reference wavelength) using the Beer-Lambert law with the path length through the sample receiving portion 8 and an attenuation coefficient for the i^{th} analyte at the reference wavelength (for example the 1^{st} wavelength λ₁). If the attenuation coefficient for the i^{th} analyte is not known at the reference wavelength, then the coefficients Mᵢⱼ=εⱼ(λᵢ) (calculated by inverting the deconvolution (de-mixing) matrix to obtain M=FC⁻¹) may be used to convert the concentration (absorbance) cᵢ at the reference wavelength to an absorbance at a wavelength for which the attenuation coefficient is known.

Equivalently, since A^{T}=c^{T}M^{T}, an alternative fingerprint matrix G may be defined by setting the coefficients of each reference absorbance vector A₁, . . . , A_{N} as the coefficients for a corresponding row of the alternative fingerprint matrix G:

$$G = ( \begin{matrix}← & {A}_{1} & \to \\ ← & {A}_{2} & \to \\ & ⋮ & \\ ← & {A}_{N} & \to \end{matrix} ) \qquad ( 10 b )$$

and the corresponding calibration concentration vectors c₁, . . . , c_{N} may be set as the rows of an alternative calibration matrix D:

$$D = ( \begin{matrix}← & {c}_{1} & \to \\ ← & {c}_{2} & \to \\ & ⋮ & \\ ← & {c}_{N} & \to \end{matrix} ) \qquad ( 11 b )$$

and the alternative fingerprint matrix G and alternative calibration matrix D are related according to:

G=DM^{T} (12b)

Thus, a set of unknown concentrations cᵢ represented by a concentration vector c may equivalently be recovered using G⁻¹D as a deconvolution matrix for the measured absorbances A(λₙ) represented by an absorbance vector A^{T} according to:

c=A^{T}G⁻¹D (13b)

It is preferable for each analyte to have an absorbance peak which corresponds to one of the illumination wavelengths λ₁, . . . , λ_{N}. It is preferred for the absorbance peaks corresponding to the N−1 types of analyte to avoid substantially overlapping. If the absorbance spectra of analytes are too similar, this may lead to errors in determining the analyte concentrations cᵢ. In practice, the number of analytes may be limited by the distinguishability of spectra.

In some examples, it may be convenient to normalise absorbance values with respect to a single reference calibration value, for example, A₁(λ¹). For example, with normalisation relative to A₁(λ₁), a normalised fingerprint matrix Fₙ may be expressed as:

$$F = ( \begin{matrix}1 & \frac{{A}_{2} ( {λ}_{1} )}{{A}_{1} ( {λ}_{1} )} & … & \frac{{A}_{N} ( {λ}_{1} )}{{A}_{1} ( {λ}_{1} )} \\ \frac{{A}_{1} ( {λ}_{2} )}{{A}_{1} ( {λ}_{1} )} & \frac{{A}_{2} ( {λ}_{2} )}{{A}_{1} ( {λ}_{1} )} & … & \frac{{A}_{N} ( {λ}_{2} )}{{A}_{1} ( {λ}_{1} )} \\ ⋮ & ⋮ & ⋱ & ⋮ \\ \frac{{A}_{1} ( {λ}_{N} )}{{A}_{1} ( {λ}_{1} )} & \frac{{A}_{2} ( {λ}_{N} )}{{A}_{1} ( {λ}_{1} )} & … & \frac{{A}_{N} ( {λ}_{N} )}{{A}_{1} ( {λ}_{1} )}\end{matrix} ) \qquad ( 10 c )$$

Each of Equations 6 to 13 and Equations 10b to 13b may be normalised in this manner, to allow absorbance and concentration values to be expressed as fractions with respect to a reference calibration value, for example A₁(λ₁).

### Determination of Concentration and Calibration Matrix Values

The calibration is simplified in the case that pure (or substantially pure) samples of the N−1 different analytes having known concentration cᵢ are available for testing in reference conditions, for example, supported on a porous strip 19. One of the calibration samples should correspond to only the background scattering s(λₙ), e.g. the porous strip 19. In this case, determining the calibration matrix is simplified, since the determination of the concentration cᵢ for each analyte at the reference wavelength can be simplified. For example, if the N^{th} calibration sample includes only the background scattering, then a calibration concentration cᵢ⁰ of the i^{th} calibration sample (1≤i≤N−1), which includes the pure (or substantially pure) i^{th} analyte, using the 1^{st} wavelength λ₁ as the reference wavelength, may be approximated as:

cᵢ⁰Aᵢ(λ₁)−A_{N}(λ₁) (14)

In which Aᵢ(λ₁) is the measured absorbance of the pure or substantially pure sample of the i^{th} analyte at the 1^{st} wavelength. The calibration matrix C may be written as:

$$C = ( \begin{matrix}{c}_{1}^{0} & 0 & … & 0 & 0 \\ 0 & {c}_{2}^{0} & … & 0 & 0 \\ ⋮ & ⋮ & ⋱ & ⋮ & ⋮ \\ 0 & 0 & 0 & {c}_{N - 1}^{0} & 0 \\ {c}_{s} & {c}_{s} & {c}_{s} & {c}_{s} & {c}_{s}\end{matrix} ) \qquad ( 15 )$$

In which the dummy concentration cₛ=A_{N}(λ₁). In this special case, the calculation of the deconvolution matrix CF⁻¹ may be simplified.

The calibration matrix C and the calculation of the deconvolution matrix CF⁻¹ may be simplified further if the absorbance of pure (or substantially pure) samples of the different analytes may be tested under conditions in which the background scattering is very low or negligible. Under these optimum conditions, the calibration matrix is diagonal, and reference concentration values may be directly set to measured absorbance values at the reference wavelength:

$$C = ( \begin{matrix}{A}_{1} ( {λ}_{1} ) & 0 & … & 0 & 0 \\ 0 & {A}_{2} ( {λ}_{1} ) & … & 0 & 0 \\ ⋮ & ⋮ & ⋱ & ⋮ & ⋮ \\ 0 & 0 & 0 & {A}_{N - 1} ( {λ}_{1} ) & 0 \\ 0 & 0 & 0 & 0 & {c}_{s}\end{matrix} ) \qquad ( 16 )$$

In which the dummy concentration cₛ=A_{N}(λ₁). Each of Equations 14 to 16 may be normalised to a reference calibration absorbance value, for example A₁(λ₁), as explained hereinbefore.

### Application to One Analyte and Background Scattering

The method of extracting optical densities for N−1 analytes using N illumination wavelengths may be applied to verify the previously applied result for a single analyte with sequential illumination at first and second wavelengths λ₁, λ₂, i.e. A₁(x)-A₂(x).

Simulations were conducted using the model described hereinbefore with reference to FIGS. 37 to 40 in a case where the blue dye concentration profile log was equal to zero at every position. The resulting simulated OPD signals 112b, 114b and simulated absorbance profiles are as shown in FIGS. 41, 42 and 44. The concentration values were chosen corresponding to absorbance fingerprint values, and taking the values corresponding to the green OLED as reference values. A first simulated calibration sample corresponding to gold nanoparticles having an optical density of OD=1 may be represented in the method by the concentration vector c_{Au}^{T}=(1, 0) and the corresponding absorbance vector is A_{Au}^{T}=(1, 0.02). The relevant absorbance values were obtained as absorbance fingerprint values as described hereinbefore with reference to FIGS. 45 and 46. A second simulated calibration sample, corresponding to a blank porous strip 19 in the form of a nitrocellulose strip, may be represented in the method by the absorbance vector A_{NC}^{T}=(0.01, 0.01), so that the dummy concentration cₛ=0.01 and the corresponding concentration vector is c_{NC}^{T}=(0, 0.01). The relevant absorbance values were obtained as absorbance fingerprint values as described hereinbefore with reference to FIGS. 45 and 46. Thus, taking the green OLED wavelength range (see FIG. 37) as the reference, the calibration matrix C and fingerprint matrix F according to Equations 11, 12 and 17 may be written as:

$$C = ( \begin{matrix}1 & 0 \\ 0 & 0.01\end{matrix} ) \\ F = ( \begin{matrix}1 & 0.01 \\ 0.02 & 0.01\end{matrix} ) \qquad ( 17 )$$

The deconvolution (de-mixing) matrix CF⁻¹ of Equation 14 may be calculated by inverting the fingerprint matrix F:

$${CF}^{- 1} = ( \begin{matrix}1 & 0 \\ 0 & 0.01\end{matrix} ) ( \begin{matrix}1.020 & - 1.020 \\ - 2.041 & 102.041\end{matrix} ) \\ {CF}^{- 1} = ( \begin{matrix}1.020 & - 1.020 \\ - 0.020 & 1.020\end{matrix} ) \qquad ( 18 )$$

and substituting the deconvolution (de-mixing) matrix CF⁻¹ into Equation 14 yields:

$$( \begin{matrix}{c}_{Au} \\ {c}_{NC}\end{matrix} ) = ( \begin{matrix}1.020 & - 1.020 \\ - 0.020 & 1.020\end{matrix} ) ( \begin{matrix}{A}_{green} \\ {A}_{NIR}\end{matrix} ) \qquad ( 19 )$$

Thus, the concentration c_{Au} of gold nanoparticles, in this example expressed in terms of absorbance in OD, is given as c_{Au}=1.02(A_{green}−A_{NIR}), which is essentially the same result applied hereinbefore.

Application to One Analyte and Background Scattering with a Coloured Dye

Simulations were also conducted using the model described hereinbefore with reference to FIGS. 37 to 40 in a case where the blue dye concentration profile 109 was as shown in FIG. 39. The resulting simulated OPD signals 112, 113, 114 are shown in FIG. 40. The concentration values were chosen as absorbance values using the green LED emission wavelengths as reference.

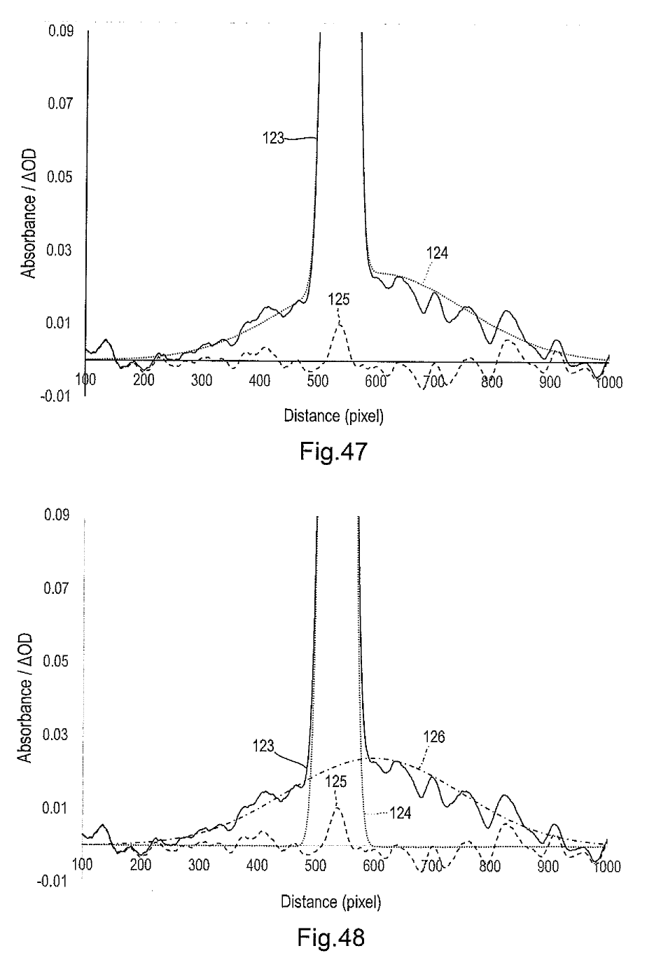

Referring also to FIG. 47, application of the simple two-colour method to absorbance values obtained based on the simulated OPD signals 112, 113, 114 leads to inaccuracy in determining the absorbance due to the gold nanoparticles when only the green and NIR simulated OPD signals 112, 114 are considered.

The total, summed absorbance 123 is represented by a solid line. The estimated gold nanoparticle concentration 124 is represented by a dotted line. The estimated background scattering from the nitrocellulose strip 125 is represented by the dashed line.

In particular, the presence of the blue dye leads to errors in the estimated gold nanoparticle concentration 124. In particular, the baseline absorbance around the location of the gold nanoparticles is distorted by absorbance of the blue dye. The problem is that there are three unknowns in the concentration values, namely, the gold nanoparticle concentration c_{Au}, the blue dye concentration c_{dye} and the background scattering c_{NC} from the nitrocellulose strip. Using green and NIR OLEDs, there are only two measurements. The solution is to increase the number of wavelength ranges to three.

The deconvolution (de-mixing) matrix method may be applied if all three of the simulated OPD signals 112, 113, 114 are utilised. A first simulated calibration sample, corresponding to gold nanoparticles having an optical density of OD=1, may be represented in the method by the concentration vector c_{Au}^{T}=(1, 0, 0) (c_{Au}, c_{dye}, c_{NC}) and the corresponding absorbance vector is A_{Au}^{T}=(1, 0.17, 0.02) (green, red, NIR). The relevant absorbance values were obtained as absorbance fingerprint values according to a method analogous to that described hereinbefore with reference to FIGS. 45 and 46. A second simulated calibration sample, corresponding to the blue dye, may be represented in the method by the concentration vector c_{dye}^{T}=(0, 0.024, 0) and the corresponding absorbance vector is A_{Au}^{T}=(0.024, 0.89, 0). The relevant absorbance values were obtained as absorbance fingerprint values according to a method analogous to that described hereinbefore with reference to FIGS. 45 and 46. A third simulated calibration sample, corresponding to a blank porous strip, has an absorbance vector of A_{NC}^{T}=(0.01, 0.01, 0.01), so that the dummy concentration cₛ=0.01 and the corresponding concentration vector is c_{NC}^{T}=(0, 0, 0.01). The relevant absorbance values were obtained as absorbance fingerprint values according to a method analogous to that described hereinbefore with reference to FIGS. 45 and 46. Thus, taking the green wavelength as reference wavelength, the calibration matrix C and fingerprint matrix F according to Equations 11, 12 and 17 may be written as:

$$c = ( \begin{matrix}1 & 0 & 0 \\ 0 & 0.024 & 0 \\ 0 & 0. & 0.01\end{matrix} ) \\ F = ( \begin{matrix}1 & 0.024 & 0.01 \\ 0.17 & 0.89 & 0.01 \\ 0.02 & 0 & 0.01\end{matrix} ) \qquad ( 20 )$$

The deconvolution (de-mixing) matrix CF⁻¹ of Equation 14 may be calculated by inverting the fingerprint matrix F:

$${CF}^{- 1} = ( \begin{matrix}1 & 0 & 0 \\ 0 & 0.024 & 0 \\ 0 & 0. & 0.01\end{matrix} ) ( \begin{matrix}1.025 & - 0.028 & - 0.997 \\ - 0.173 & 1.128 & - 0.956 \\ - 2.049 & 0.055 & 101.994\end{matrix} ) \\ {CF}^{- 1} = ( \begin{matrix}1.025 & - 0.028 & - 0.997 \\ - 0.004 & 0.027 & - 0.023 \\ - 0.02 & 0.001 & 1.020\end{matrix} ) \qquad ( 21 )$$

and substituting the deconvolution (de-mixing) matrix CF⁻¹ into Equation 14 yields:

$$( \begin{matrix}{c}_{Au} \\ {c}_{dye} \\ {c}_{NC}\end{matrix} ) = ( \begin{matrix}1.025 & - 0.028 & - 0.997 \\ - 0.004 & 0.027 & - 0.023 \\ - 0.02 & 0.001 & 1.020\end{matrix} ) ( \begin{matrix}{A}_{green} \\ {A}_{red} \\ {A}_{NIR}\end{matrix} ) \qquad ( 22 )$$

Thus, the concentration c_{Au} of gold nanoparticles, in this example expressed in terms of absorbance in OD, is given as c_{Au}=1.025A_{green}−0.028A_{red}−0.997A_{NIR}).

Referring also to FIG. 48, the total, summed absorbance 123 is represented by a solid line. The estimated gold nanoparticle concentration 124 is represented by a dotted line. The estimated background scattering from the nitrocellulose strip 125 is represented by the dashed line. The estimated concentration of the blue dye 126 is represented by the chained line.

It can be seen that applying the method of sequential measurements at three different wavelengths (green, red and NIR) is expected to allow for clear separation of the absorbance due to the gold nanoparticles, blue dye and the nitrocellulose strip. In particular, the estimated gold nanoparticle concentration 124 and the estimated concentration of the blue dye 126 are expected to be separable.

The hereinbefore described deconvolution (de-mixing) method may be carried out by the controller 27 of the analytical test device 1.

### Interdigitated LED Array

LED arrays 60 have been described in which, for example, the first and second light emitters 2, 3 are stacked on top of each other (see FIGS. 25 and 26), or in which a plurality of first and second light emitters 2, 3 are arranged in an array in which the first and second light emitters 2, 3 alternate in a “chess-board” pattern (FIG. 27). However, other arrangements of LED array 60 may be used.

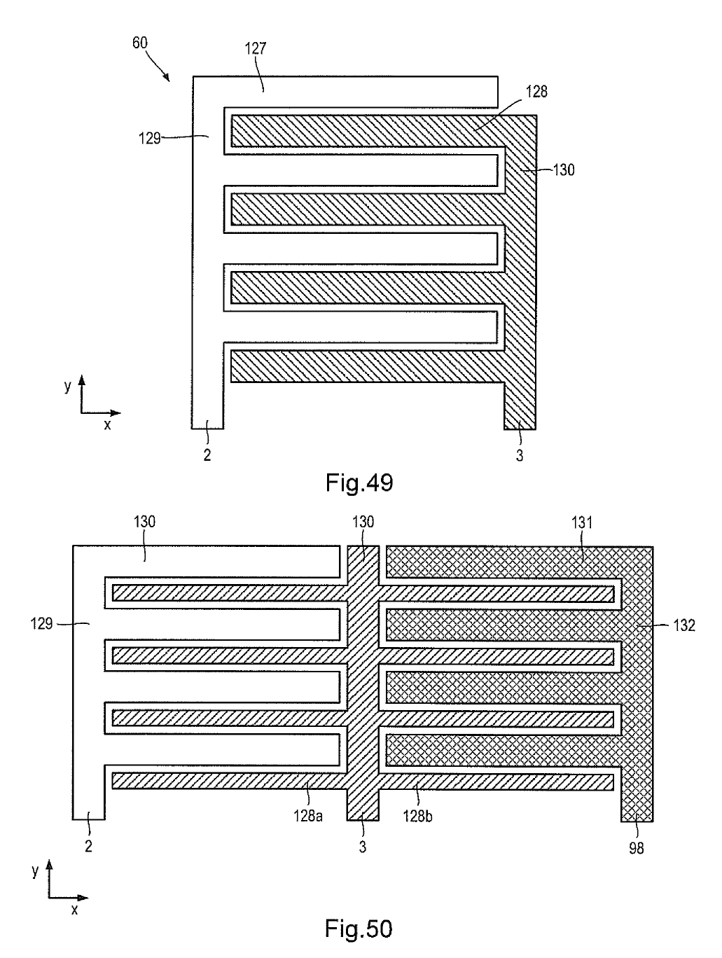

For example, referring also to FIG. 49, a third example of an LED array 60 is shown. A first light emitter 2 includes a number of protrusions 127 arranged parallel to one another and interdigitated with a number of protrusions 128 of a second light emitter 3. The protrusions 127 of the first light emitter 2 are joined to form a single light emitter 2 by a backbone segment 129. Similarly, the protrusions 128 of the second light emitter 3 are joined to form a single light emitter 3 by a backbone segment 130. An LED array 60 may include one or more pairs of such interdigitated first and second light emitters 2, 3. The numbers of protrusions 127, 128 is not limited. The number of protrusions 127 of the first light emitter 2 need not be equal to the number of protrusions 128 of the second light emitter 3. The LED array 60 may be arranged so that only the protrusions 127, 128 overlap a region of interest and so that the backbone segments 129, 13o do not overlap a region of interest. The protrusions 127, 128 do not need to extend perpendicularly from the corresponding backbone segments 129, 130.

In an alternative arrangement (not shown) of interdigitated first and second light emitters 2, 3, protrusions 127, 128 may extend from two sides of corresponding backbone segments 129, 130. Protrusions 127, 128 extending from opposite sides of a backbone segment 129, 130 may be arranged opposite one another, or not. Protrusions 127, 128 extending from one side of a backbone segment 129, 130 do not need to extend parallel to protrusions 127, 128 extending from the opposite side of the same backbone segment 129, 130.

A two-colour interdigitated LED array may be particularly compact for transmission measurements, but may also be used for reflectance measurements.

LED arrays 60 have been described which include pixels 99 having subpixels in the form of first, second and third light emitters 2, 3 98 (FIG. 36A).

Referring also to FIG. 50, first, second and third light emitters 2, 3, 98 may be interdigitated in a fourth example of an LED array 60.

A first light emitter 2 includes a number of protrusions 127 arranged parallel to one another, and interdigitated with a number of first protrusions 128a of a second light emitter 3. The protrusions 127 of the first light emitter 2 are joined to form a single light emitter 2 by a backbone segment 129. Similarly, the first protrusions 128a of the second light emitter 3 are joined to form a single light emitter 3 by a backbone segment 130. Unlike the first light emitter 3, the light second emitter 3 also includes second protrusions 128b which extend from the opposite edge of the backbone segment 130 to the first protrusions 128a, and which are interdigitated with a number of protrusions 131 of a third light emitter 98. The protrusions 131 of the third light emitter 98 are joined to form a single light emitter 98 by a backbone segment 132. The width of the protrusions 128a, 182b of the second light emitter 3, may be relatively smaller than the protrusions 127, 131 of the first and third light emitters 2, 98, in order to maintain comparable emissive areas between the first, second and third light emitters 2, 3, 98. For example, if the protrusions 127, 128, 131 extend from the respective backbone segments 129, 130, 132 in a first direction x, then the width of the protrusions 128a, 182b of the second light emitter 3 in a second direction y may be less than the corresponding width of the protrusions 127, 131 of the first and third light emitters 2, 98 in the second direction y.

The second light emitter 3 need not be placed between the first and third light emitters 2, 98. Alternatively, either the first light emitter 2 or the third light emitter 98 may be arranged to provide the central element of a three colour interdigitated LED array 60. An LED array 60 may include one or more triplets of such interdigitated first, second and third light emitters 2, 3. The numbers of protrusions 127, 128, 131 is not limited. A three-colour interdigitated LED array may be particularly compact for transmission measurements, but may also be used for reflectance measurements.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention.

The applicant hereby gives notice that new claims may be formulated to such features and/or combinations of such features during the prosecution of the present application or of any further application derived therefrom.

1. An analytical test device comprising:
two or more sets of emitters, each set of emitters comprising one or more light emitters configured to emit light within a range around a corresponding wavelength, wherein each set of light emitters is configured to be independently illuminable; and
one or more photodetectors arranged such that light from each set of emitters reaches the photodetectors via an optical path comprising a sample receiving portion, and
wherein the emitters and photodetectors are configured such that, at the sample receiving portion of the optical path, a normalised spatial intensity profile generated by each set of emitters is substantially equal to a normalised spatial intensity profile generated by each other set of emitters;
a liquid transport path comprising a first end, a second end and a liquid sample receiving region, the liquid transport path configured to transport a liquid sample received in the liquid sample receiving region towards the second end and through the sample receiving portion of the optical path.

2. An analytical test device according to claim 1, further comprising a controller configured to:
sequentially illuminate each set of emitters and to obtain a corresponding measured absorbance value using the photodetectors, such that only one set of emitters is illuminated at any time;
generate an absorbance vector using the measured absorbance values; and
determine a concentration vector by multiplying the absorbance vector with a de-convolution matrix.

3. An analytical test device according to claim 1, wherein the two or more sets of emitters comprise:
a set of first light emitters configured to emit within a range around a first wavelength; and
a set of second light emitters configured to emit within a range around a second wavelength.

4. An analytical test device according to claim 3, wherein the two or more sets of emitters further comprise:
a set of third light emitters configured to emit within a range around a third wavelength.

5. An analytical test device according to claim 1, wherein the optical path is configured such that the photodetectors receive light transmitted through the sample receiving portion of the optical path.

6. An analytical test device according to claim 1, wherein the optical path is configured such that the photodetectors receive light reflected from the sample receiving portion of the optical path.

7. An analytical test device according to claim 1, wherein the photodetectors form an image sensor arranged to image all or a portion of the sample receiving portion of the optical path.

8. An analytical test device according to claim 1, wherein the optical path further comprises a slit arranged before the sample receiving portion;
wherein each set of emitters is arranged to illuminate the slit.

9. An analytical test device according to claim 1, wherein the two or more sets of emitters comprises a set of second emitters, and wherein each second emitter is substantially transparent at the wavelengths emitted by each other set of emitters, and wherein each other emitter emits light into the optical path through a corresponding second emitter.

10. An analytical test device according to claim 3, wherein each second emitter is substantially transparent at the wavelengths emitted by each first emitter, and wherein each first emitter emits light into the optical path through a corresponding second emitter.

11. An analytical test device according to claim 4, wherein each second emitter is substantially transparent at the wavelengths emitted by each first emitter and each third emitter, and wherein each first emitter and each third emitter emits light into the optical path through a corresponding second emitter.

12. An analytical test device according to claim 1, wherein the two or more sets of emitters are arranged into an array comprising a plurality of pixels, wherein each pixel comprises at least one subpixel and each subpixel comprises a light emitter corresponding to each set of emitters.

13. An analytical test device according to claim 1, wherein two or three sets of emitters are interdigitated with one another to form an array.

14. An analytical test device according to claim 1, wherein the liquid transport path comprises a lateral flow type strip.

15. An analytical test device according to claim 1, wherein the liquid transport path comprises the whole, a part, or at least one channel of a microfluidic device.

16. An analytical test device according to claim 1, wherein the controller is further configured to intersperse illumination of each set of emitters with periods when none of the sets of emitters is illuminated.

17. An analytical test device according to claim 1, further comprising at least one output device.

18. An analytical test device according to claim 17, wherein the at least one output device comprises one or more light emitting diodes, and wherein the controller is configured to illuminate each light emitting diode in response to a corresponding value of the concentration vector exceeding a predetermined threshold.

19. An analytical test device according to claim 17, wherein the at least one output device comprises a display element, and wherein the controller is configured to cause the display element to display one or more outputs in response to determining the concentration vector.

20. An analytical test device according to claim 19, wherein the controller is configured, in response to a value of the concentration vector exceeding a predetermined threshold, to cause the display element to display a corresponding symbol or symbols.

21-24. (canceled)
